(19) United States
(12) Patent Application Publication
(10) Pub. No.: US 2026/0031933 A1
(43) Pub. Date: Jan. 29, 2026

(54) HARQ FOR SOURCE CODING

(71) Applicant: Huawei Technologies Co., Ltd., Shenzhen (CN)

(72) Inventors: Liqing Zhang, Ottawa (CA); Hao Tang, Ottawa (CA); Jianglei Ma, Ottawa (CA)

(21) Appl. No.: 19/335,574

(22) Filed: Sep. 22, 2025

Related U.S. Application Data
(63) Continuation of application No. PCT/CN2023/077030, filed on Mar. 23, 2023.

(51) Int. Cl. H04L 1/1812

(52) U.S. Cl. CPC H04L 1/1812

(57) ABSTRACT

A HARQ method implemented in relation to channel coding may be suboptimal in that the HARQ method does not leverage features of the source coding. For example, it makes no difference to the HARQ method whether source coding is even performed, let alone whether some portions of the compressed bits output from the source encoder have higher levels of priority, e.g. higher levels of importance to the success of the source decoding. In some embodiments, a HARQ method for source coding is provided. The HARQ method for source coding may be performed with or without channel coding. A first set of source encoded bits may be sent in a first transmission (e.g. an initial transmission), and a second set of source encoded bits may be sent in a second transmission (e.g. a retransmission) based on feedback. The feedback may be an indication of source decoding outcome.

### CROSS-REFERENCE TO RELATED APPLICATION

This application is a continuation of International Application No. PCT/CN2023/077030, filed on Mar. 23, 2023, which is hereby incorporated by reference in its entirety.

### TECHNICAL FIELD

The present application relates to source coding in the physical layer of a digital communication system, such as in the physical layer of a wireless communication system.

### BACKGROUND

In a digital communication system, the bits of information to be transmitted over a channel to a receiving device may undergo source encoding in the physical layer. Source encoding is compression by encoding the bits to use fewer bits than the original representation. Therefore, source encoding is also called data compression or bit-rate reduction. The source encoding referred to herein is primarily source encoding in the physical layer, and may exist independent of compression techniques that might or might not be applied at higher layers (e.g. the application layer) of the network.

The source encoded bits (i.e. the compressed bits) may be subsequently decompressed via source decoding. For example, bits of information may be source encoded by a transmitting device, transmitted over a channel, received by a receiving device, and source decoded by the receiving device. The process of source encoding/decoding may be referred to as source coding. A known example implementation of source coding is the Lempel-Ziv-Welch (LZW) algorithm.

The compression performed by the source encoding may be lossless or lossy. Lossless compression is compression in which no information is lost in the compression, assuming no errors are introduced during transmission of the compressed bits over the channel. For example, a lossless compression algorithm may reduce the number of information bits by identifying and eliminating statistical redundancy. Lossy compression is compression in which some of the original information is lost by the compression and cannot be recovered during the decompression. For example, unnecessary or less important information may be dropped during the source encoding. Both lossless and lossy source coding methods are known.

In addition to source encoding, channel encoding may also be implemented to apply forward error correction in which redundancy (e.g. parity bits) are added to be used by the receiving device to try to correct errors introduced during transmission. For example, after source encoding, but prior to modulation, a channel encoder may perform channel encoding to apply forward error correction, e.g. to map L bits to L+P bits, where P are redundant bits in the form of parity bits. Channel encoded bits are transmitted over the channel to the receiving device. During the transmission, errors may be introduced. The receiving device applies channel decoding in which at least some of the parity bits are used to try to correct one or more errors introduced during transmission. The process of channel encoding/decoding may be referred to as channel coding. A known example implementation of channel coding is low-density parity-check (LDPC) coding.

A wireless communication system typically implements digital communication. Electronic devices, such as user equipments (UEs), wirelessly communicate with a network via one or more transmit-and-receive points (TRPs). A transport block (TB) includes bits of information, such as data and/or control information, to be transmitted over the wireless channel. Hybrid automatic repeat request (HARQ) is a method in which channel coding is implemented to try to correct errors, but if the receiving device is unable to correct all errors a retransmission is performed. The HARQ method provides a framework for managing the retransmission so that, for example, the transmitting device knows when it needs to retransmit, and the receiving device knows whether a received packet is an initial or retransmission, and if it is a retransmission, the receiving device knows the TB to which the retransmission relates. For example, the HARQ method may operate such that a receiving device is to return a negative acknowledgement (NACK) if a retransmission is required, and a HARQ process ID may be used to associate a retransmission with a particular TB.

In current systems, HARQ is implemented in relation to the channel coding, e.g. as explained above.

### SUMMARY

A HARQ method implemented in relation to channel coding may be suboptimal in that the HARQ method does not leverage features of the source coding. For example, it makes no difference to the HARQ method whether source coding is even performed, let alone whether some portions of the compressed bits output from the source encoder have higher levels of priority, e.g. higher levels of importance (interchangeably called “significance”) to the success of the source decoding. For example, assume a transport block (TB) is compressed by a source encoder to result in an output of L source encoded bits consisting of k portions of bits L1 to Lk. Each portion may be a block of source encoded bits. One of the blocks (e.g. block L1) might be higher priority than the other blocks, e.g. in terms of the ability of the receiving device to successfully perform source decoding. However, the HARQ retransmission does not take this into account, e.g. the more important block is not intentionally favoured over less important blocks when retransmission is performed.

In some embodiments herein, a HARQ method for source coding is provided. The HARQ method for source coding may be performed without channel coding or in conjunction with channel coding such as forward error correction (FEC), depending upon the embodiment. In some embodiments, the receiving device determines whether a retransmission of one or more blocks of compressed bit is required, and if so retransmission of a higher priority block is favoured. In one example, for each block of compressed bits output by the source encoder, a cyclic redundancy check (CRC) value is computed by the transmitting device and appended to that block. For each received block, the receiving device uses the CRC value to detect whether that received block has an error. Retransmission of a higher priority block is favoured if multiple blocks have an error. In another example, instead of or in addition to a CRC value to detect an error, the receiving device may complete the source decoding and determine the amount of distortion in the information represented by the decompressed bits. The location and/or amount of distortion may indicate that certain blocks were received with errors, and retransmission of a higher priority block is favoured.

In some embodiments, forward error correction might not be performed, e.g. there might only be source coding possibly with the implementation of CRC values to detect errors in source encoded bits. However, in other embodiments, channel encoding may additionally be performed to apply forward error correction to the source encoded bits, in which case the retransmission(s) managed by the HARQ method may include the retransmission of redundant bits, e.g. parity bits, generated by the forward error correction coding.

In some embodiments, a method performed by a device may include performing source encoding of information to result in source encoded bits. The method may further include transmitting, in a first transmission, a first set of the source encoded bits comprising some or all of the source encoded bits. The method may further include receiving an indication of source decoding outcome. In response to receiving the indication of source decoding outcome, the method may further include transmitting, in a second transmission, a second set of the source encoded bits comprising some or all of the source encoded bits. In some embodiments, a method performed by a device may include receiving, in a first transmission, a first set of source encoded bits. The method may further include transmitting an indication of source decoding outcome based on the first set of source encoded bits received in the first transmission. The method may further include subsequently receiving, in a second transmission, a second set of source encoded bits.

In some embodiments, the second set of the source encoded bits may include only a subset of the source encoded bits transmitted in the first transmission. For example, multiple portions/blocks of source encoded bits may be included in the first transmission, and the second transmission may include only a higher priority portion/block, e.g. the second transmission may omit a portion of the source encoded bits of lower priority (e.g. of lower importance to the source decoding). In some embodiments, forward error correction channel encoding may be performed to generate parity bits, and a first set of the parity bits may be included in the first transmission and a second set of the parity bits may be included in the second transmission. In some such embodiments, the forward error correction channel encoding may be performed on all of the source encoded bits to generate the parity bits, with the first set of the parity bits and the second set of the parity bits each being different subsets of the parity bits. In other such embodiments, the forward error correction channel encoding may be performed on the source encoded bits included in the first transmission to generate the first set of parity bits, and the forward error correction channel encoding may be separately performed on the source encoded bits included in the second transmission to generate the second set of parity bits.

Technical benefits of some embodiments include the application of HARQ retransmission to source coding, which may provide a possibly more optimal HARQ process in terms of fewer errors and/or fewer retransmissions. In some embodiments, bandwidth may be saved by focussing retransmission on just the most important blocks of compressed bits.

Corresponding devices for performing the methods herein are also disclosed.

According to an aspect of the disclosure, there is provided a non-transitory computer readable storage medium, wherein the computer readable storage medium stores instructions that, when executed by a processor of an apparatus, enable the apparatus to perform a method as described above.

### BRIEF DESCRIPTION OF THE DRAWINGS

Embodiments will be described, by way of example only, with reference to the accompanying figures wherein:

FIG. 1 is a simplified schematic illustration of a communication system, according to one example;

FIG. 2 illustrates another example of a communication system;

FIG. 3 illustrates an example of an electronic device (ED), a terrestrial transmit and receive point (T-TRP), and a non-terrestrial transmit and receive point (NT-TRP);

FIG. 4 illustrates example units or modules in a device;

FIG. 5 illustrates a transmitting device communicating with a receiving device, according to some embodiments;

FIG. 6 illustrates an example of a circular buffer storing the systematic and parity bits output from channel encoding;

FIG. 7 illustrates a method performed by a transmitting device and a receiving device, according to some embodiments;

FIGS. 8 and 9 illustrate examples of transmission of source encoded bits, according to some embodiments;

FIGS. 10 and 11 illustrate source compression versions (SCVs) and code redundancy versions (CRVs) used for multiple transmissions, according to some embodiments;

FIGS. 12 to 15 illustrate example source coding retransmission protocols;

FIG. 16 illustrates one example way in which SCVs may be mapped to different blocks of source encoded bits;

FIG. 17 illustrates different example SCV sizes;

FIG. 18 illustrates an example method of retransmission in which compression rates (CpRs) are implemented; and

FIG. 19 illustrates a system architecture for wireless communication, according to some embodiments.

### DETAILED DESCRIPTION

For illustrative purposes, specific example embodiments will now be explained in greater detail below in conjunction with the figures.

Although not necessary, the methods described herein may be implemented in a communication system that implements wireless communication. Therefore, an example communication system that includes wireless communication is first described below.

### Example Communication Systems and Devices

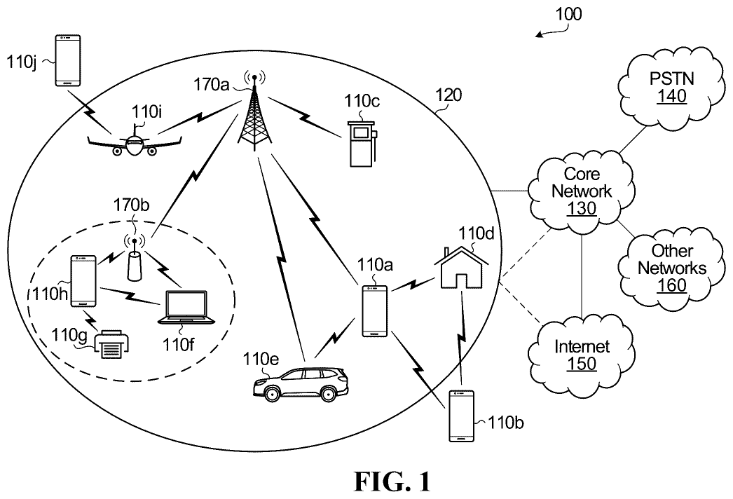

Referring to FIG. 1, as an illustrative example without limitation, a simplified schematic illustration of a communication system 100 is provided. The communication system 100 comprises a radio access network (RAN) 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

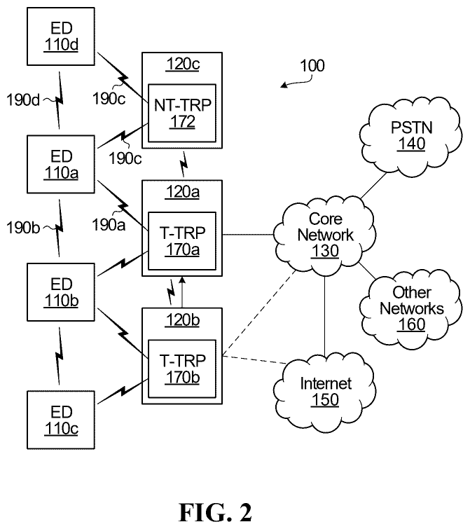

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c (which may also be a RAN or part of a RAN), a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

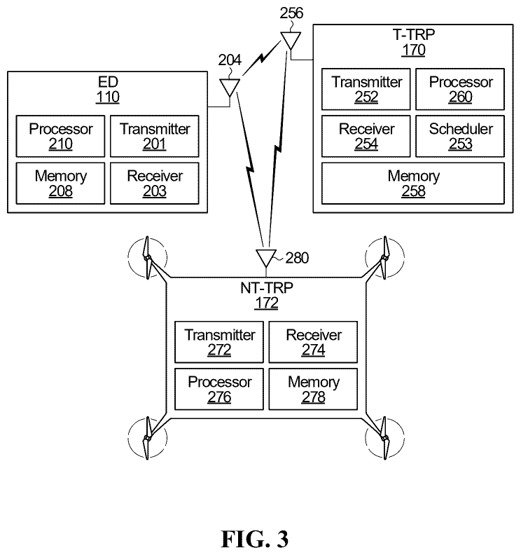

FIG. 3 illustrates another example of an ED 110, a base station 170 (e.g. 170a and/or 170b), which will be referred to as a T-TRP 170, and a NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transmitter (or transceiver) is configured to modulate data or other content for transmission by the at least one antenna 204 or network interface controller (NIC). The receiver (or transceiver) is configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the forgoing devices or apparatus (e.g. communication module, modem, or chip) in the forgoing devices.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations which may be described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170. The scheduler 253 may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone, it is only as an example. The NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

Note that “TRP”, as used herein, may refer to a T-TRP or a NT-TRP.

The T-TRP 170, the NT-TRP 172, and/or the ED 110 may include other components, but these have been omitted for the sake of clarity.

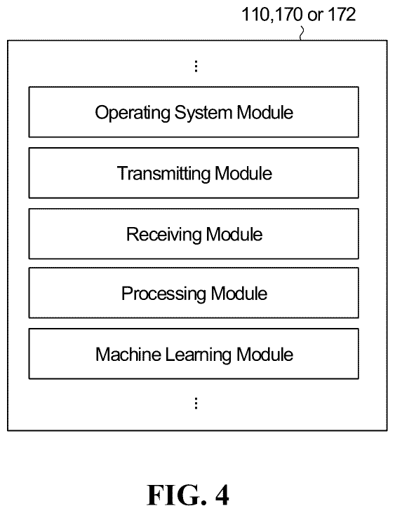

One or more steps of the embodiment methods provided herein may be performed by corresponding units or modules, e.g. according to FIG. 4. FIG. 4 illustrates example units or modules in a device, such as in ED 110, in T-TRP 170, or in NT-TRP 172. For example, operations may be controlled by an operating system module. As another example, a signal may be transmitted by a transmitting unit or a transmitting module. A signal may be received by a receiving unit or a receiving module. A signal may be processed by a processing unit or a processing module. Some operations/steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Control information is mentioned herein. Control information may sometimes instead be referred to as control signaling, or signaling. In some cases, control information may be dynamically communicated, e.g. in the physical layer in a control channel, such as in a physical uplink control channel (PUCCH) or physical downlink control channel (PDCCH). An example of control information that is dynamically indicated is information sent in physical layer control signaling, e.g. uplink control information (UCI) sent in a PUCCH or downlink control information (DCI) sent in a PDCCH. A dynamic indication may be an indication in lower layer, e.g. physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g. physical layer control signaling sent in the physical layer, such as DCI sent in a PDCCH or UCI sent in a PUCCH.

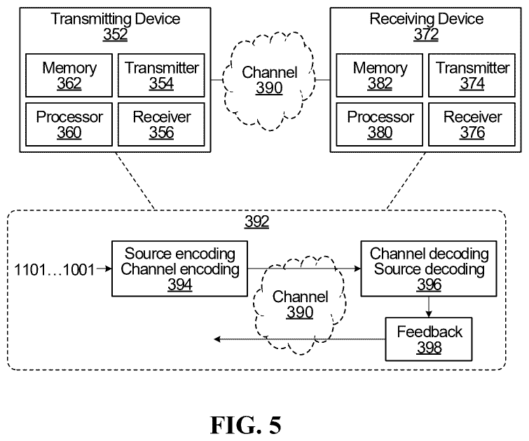

FIG. 5 illustrates a transmitting device 352 communicating with a receiving device 372, according to some embodiments. The term “transmitting device” is used for ease of explanation to refer to the device that, in the examples explained herein, is the device that has information to source encode and transmit. The term “receiving device” is used for ease of explanation to refer to the device that, in the examples explained herein, is the device that receives the source encoded bits from the transmitting device. The transmitting device 352 may still receive communications, e.g. feedback from the receiving device 372. The receiving device 372 may still transmit communications, e.g. feedback. For example, the receiving device 372 may transmit an indication of source decoding outcome back to the transmitting device 352, which may prompt the transmitting device 352 to perform a retransmission of some or all of the source encoded bits.

In some embodiments, the transmitting device 352 might be, for example, a network device such as a T-TRP or NT-TRP, and the receiving device 372 might be, for example, an electronic device (ED) such as a UE. However, this is not necessary. For example, the opposite may be true, e.g. the transmitting device 352 may be an ED such as a UE, and the receiving device 372 may be a network device such as a T-TRP or NT-TRP. As another example, the transmitting device 352 and the receiving device 372 may be the same type of entity, e.g. two UEs or two TRPs communicating with each other. In some scenarios, the transmitting device 352 and the receiving device 372 might be two entities communicating over a wired channel. The transmitting device 352 and receiving device 372 may be part of a communication system. The communication system may be or include a wireless communication system, e.g. the communication system may be communication system 100 describe above.

The transmitting device 352 includes a processor 360, which directly implements or controls the transmitting device 352 to implement the operations of the transmitting device 352 described herein. For example, the processor 360 may perform the source encoding and forward error correction parity bit generation described herein. The transmitting device 352 further includes a memory 362 for storing information, e.g. for storing the source encoded bits (e.g. the compressed systematic bits) and the parity bits discussed herein. For example, the memory 362 may implement the circular buffers described herein. The processor 360 may be implemented by a general-purpose processor that executes instructions stored in a memory (e.g. stored in memory 362). Alternatively, the processor 360 may be implemented using dedicated integrated circuitry, such as an ASIC, a GPU, or an FPGA.

The transmitting device 352 further includes a transmitter 354 for preparing and sending transmissions to the receiving device 372 over the channel 390. For example, the transmitter 354 may be implemented by a baseband processor and transmitter chain including a digital-to-analog convertor (DAC), a frequency up-convertor, a power amplifier, and one or more antennas or panels. The processing components of the transmitter 354 (e.g. some or all of a baseband processor) may be implemented by processor 360. The transmitting device 352 further includes a receiver 356 for receiving transmissions from the receiving device 372 over the channel 390. For example, the receiver may be implemented by a receiver chain including one or more antennas or panels, filters, a frequency down-convertor, and an analog-to-digital convertor (ADC), and a baseband processor. The processing components of the receiver 356 (e.g. some or all of a baseband processor) may be implemented by processor 360.

If the transmitting device 352 is T-TRP 170, then the processor 360 may be or include processor 260 and may implement scheduler 253, the memory 362 may be or include memory 258, the transmitter 354 may be or include transmitter 252, and the receiver 356 may be or include receiver 254. If the transmitting device 352 is NT-TRP 172, then the processor 360 may be or include processor 276, the memory 362 may be or include memory 278, the transmitter 354 may be or include transmitter 272, and the receiver 356 may be or include receiver 274. If the transmitting device 352 is ED 110, then the processor 360 may be or include processor 210, the memory 362 may be or include memory 208, the transmitter 354 may be or include transmitter 201, and the receiver 356 may be or include receiver 203.

The receiving device 372 includes a processor 380, which directly implements or controls the receiving device 372 to implement the operations of the receiving device 372 described herein. For example, the processor 380 may perform the source and/or channel decoding methods described herein and generate the indication of source decoding outcome. The receiving device 372 further includes a memory 382 for storing information, e.g. for storing the partially channel and source decoded bits used for HARQ combining. An example of HARQ combining is soft combining such as chase combining or incremental redundancy (e.g. incremental redundancy decoding). The processor 380 may be implemented by a general-purpose processor that executes instructions stored in a memory (e.g. stored in memory 382). Alternatively, the processor 380 may be implemented using dedicated integrated circuitry, such as an ASIC, a GPU, or an FPGA.

The receiving device 372 further includes a transmitter 374 for preparing and sending transmissions of the transmitting device 352 over the channel 390. For example, the transmitter 374 may be implemented by a baseband processor and transmitter chain including a DAC, a frequency up-convertor, a power amplifier, and one or more antennas or panels. The processing components of the transmitter 374 (e.g. some or all of a baseband processor) may be implemented by processor 380. The receiving device 372 further includes a receiver 376 for receiving transmissions from the transmitting device 352 over the channel 390. For example, the receiver may be implemented by a receiver chain including one or more antennas or panels, filters, a frequency down-convertor, and an ADC, and a baseband processor. The processing components of the receiver 376 (e.g. some or all of a baseband processor) may be implemented by processor 380.

If the receiving device 372 is T-TRP 170, then the processor 380 may be or include processor 260 and may implement scheduler 253, the memory 382 may be or include memory 258, the transmitter 374 may be or include transmitter 252, and the receiver 376 may be or include receiver 254. If the receiving device 372 is NT-TRP 172, then the processor 380 may be or include processor 276, the memory 382 may be or include memory 278, the transmitter 374 may be or include transmitter 272, and the receiver 376 may be or include receiver 274. If the receiving device 372 is ED 110, then the processor 380 may be or include processor 210, the memory 382 may be or include memory 208, the transmitter 374 may be or include transmitter 201, and the receiver 376 may be or include receiver 203.

In embodiments explained herein, it is assumed that the transmitting device 352 is transmitting information to the receiving device 372, and therefore the transmitting device 352 implements the encoding operations and the receiving device 372 implements the decoding operations and feedback. For example, as shown in stippled bubble 392, the processor 360 of the transmitting device 352 performs at least source encoding and possibly channel encoding. If both source encoding and channel encoding are performed, it may be joint source and channel encoding. The output is modulated and sent by transmitter 354 over channel 390 to receiving device 372. The receiver 376 of the receiving device 372 receives the transmission, demodulates and the processor 380 performs channel decoding (if applicable) and source decoding 396. Feedback 398 such as an indication of source decoding outcome may be sent by the transmitter 374 over the channel 390 (e.g. over a feedback channel) to the transmitting device 352 and received via receiver 356. The feedback 398 may trigger the transmitting device 352 to send a retransmission. For example, if the feedback is an indication of source decoding outcome that indicates that at least a higher priority portion of source encoded bits needs to be retransmitted (e.g. because of an error in the bits from a CRC check and/or because of distortion in the source decoded bits), then the transmitting device 352 may send a retransmission of at least the higher priority source encoded bits.

### HARQ for Source Coding

As mentioned earlier, the conventional HARQ method is limited to channel coding. The underlying traffic to be transmitted (e.g. the TB) is transparent to the HARQ method. For example, transmitting device 352 has information to send to receiving device 372. The information may be called traffic. The information may include data and/or control information. The information may be in the form of a TB. Transmitting device 352 performs source encoding of the information to result in source encoded bits. The source encoded bits are the output of the source encoding algorithm applied, e.g. the output of an LZW algorithm. The transmitting device 352 then performs channel coding on the source encoded bits to output channel encoded bits. For example, LDPC encoding may be performed to implement forward error correction (FEC) encoding and generate channel encoded bits. The channel encoded bits may include both systematic bits and parity bits. The systemic bits are the original source encoded bits output from the source encoding. The parity bits are redundant bits generated by the channel encoding algorithm for use in channel decoding. The transmitting device 352 may partition the channel encoded bits into different sets that possibly overlap with each other. Each set may be a different redundancy version (RV). Some RVs may have more parity bits than other RVs. Each RV is identified by an RV index, e.g. RV 0, RV 1, RV 2, . . . etc.

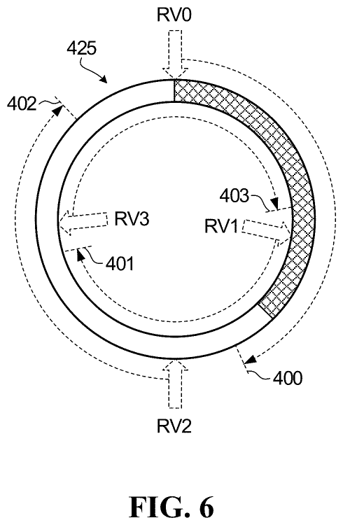

FIG. 6 illustrates an example of a circular buffer 425 in the memory 362 of transmitting device 352 storing the systematic and parity bits output from the channel encoding. The systematic bits are shown using cross-hatching, and the remaining bits in the circular buffer 425 (i.e. the bits in the white part of the circular buffer 425) are the parity bits. In this example, not all of the bits are transmitted by the transmitting device 352 in a transmission. Instead, bits corresponding to a respective RV are transmitted in a given transmission. The term “transmission”, as used herein, may refer to an initial transmission or a retransmission.

There are four RVs in the example. RV0 is the set of bits starting at the RV0 arrow to end point 400. RV1 is the set of bits starting at the RV1 arrow to end point 401. RV2 is the set of bits starting at the RV2 arrow to end point 402. RV3 is the set of bits starting at the RV3 arrow to end point 403. In operation, the transmitting device 352 first transmits the bits of RV0 in an initial transmission. If the channel decoding fails, the transmitting device 352 then transmits the bits of RV2 in a first retransmission. If the channel decoding still fails, the transmitting device 352 then transmits the bits of RV3 in a second retransmission. If the channel decoding still fails, the transmitting device 352 then transmits the bits of RV1 in a third and final retransmission. The receiving device 372 receives the initial transmission and the processor 380 of the receiving device 372 performs channel decoding. If the channel decoding fails, e.g. a CRC check fails, then the receiving device 372 may send HARQ feedback in the form of a NACK to the transmitting device 352, which informs the transmitting device 352 that the channel decoding failed. Alternatively, the absence of an ACK within a certain time period may act as a NACK, or vice versa. That is, the absence of the feedback from receiver side may act as an ACK or NACK to reduce signaling overhead, which may depend on predefinition or configuration. The first retransmission (having the bits of RV2) is received and channel decoding is performed again. If the channel decoding again fails, this is indicated to the transmitting device 352 (e.g. via a NACK) and the second retransmission (having the bits of RV3) is received and channel decoding is performed again. If the channel decoding again fails, this is indicated to the transmitting device 352 (e.g. via a NACK) and the third retransmission (having the bits of RV1) is received and channel decoding is performed again. The channel decoding may implement HARQ combining, e.g. soft-combining such as incremental redundancy (IR) in which the bits of the received RV are combined with the bits of the earlier RV(s) received. In alternative embodiments, the channel decoding may instead implement soft-combining in the form of chase combining, where initial and retransmission(s) may repeat transmissions of same modulation and coding signals for one packet data.

Because the information is transparent to the HARQ entity, systematic bits and parity bits are considered by the receiving device 372 to have equal significance for channel decoding at the receiving device 372, except that a transmission with the systematic bits or most of them (e.g. RV0 in FIG. 6) may be self-decodable. An initial transmission in IR HARQ may include systematic bits and part of parity bits (e.g. RV0 in FIG. 6), while upon decoding failure, a redundant version of incremental information may be from parity bits that are not included in the initial transmission (e.g. RV2 in FIG. 6), which may be complementary to the parity bits in the initial transmission. More retransmissions may be performed with different RVs that transmit different parts from the systematic bits and/or parity bits, e.g., RV3, RV1, etc.

The HARQ method described above may possibly result in sub-optimal performance because the HARQ method does not consider the source coding information, e.g. the features of the source encoded bits which may be such that some portions (e.g. blocks) of the source encoded bits are higher priority (e.g., in terms of significance at least to the source decoding role) than other portions of the source encoded bits. For example, some portions of the source encoded bits may be more important or possibly even essential for correct source decoding. In this sense, the HARQ method considers the source coding information as transparent, and thus during the HARQ retransmission operation no specific source coding information is utilized for possibly more efficient transmission and source decoding.

Embodiments below provide a HARQ protocol for source coding, which might or might not be implemented in conjunction with FEC channel encoding. Although the protocol is referred to as “HARQ” or “HARQ for source coding”, not all embodiments are necessarily HARQ per se, e.g. there is not necessarily any correction attempted before feedback. However, the term “HARQ” is used because the methods may be considered HARQ-like in that feedback prompting a retransmission is provided back to the transmitting device 352, e.g. in the form of an indication of source decoding outcome. The retransmission is of source encoded bits, which might be a subset of the source encoded bits in the initial transmission, e.g. only the high priority source encoded bits might be retransmitted with possibly additional or stronger FEC protection. This may increase the chance that more important source encoded bits needed for source decoding are received successfully and/or may reduce transmission overhead (e.g. if fewer source encoded bits are retransmitted and/or there are fewer retransmissions needed).

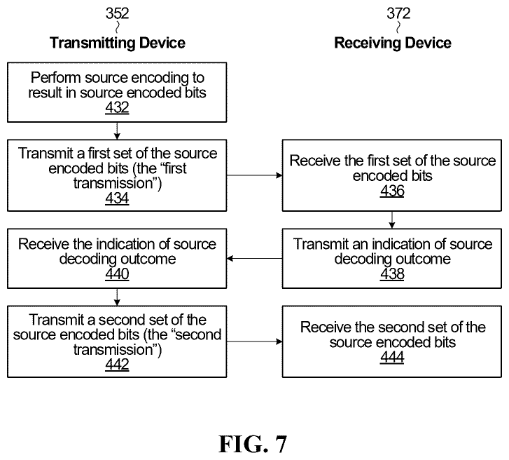

FIG. 7 illustrates a method performed by the transmitting device 352 and the receiving device 372, according to some embodiments.

At step 432, the transmitting device 352 performs source encoding of information to result in source encoded bits.

At step 434, the transmitting device 352 transmits, in a first transmission, a first set of the source encoded bits. The first set of the source encoded bits includes some or all of the source encoded bits generated at step 432.

At step 436, the receiving device 372 receives the first set of source encoded bits in the first transmission. At step 438, the receiving device 372 transmits an indication of source decoding outcome based on the first set of source encoded bits received in the first transmission. Example ways for the receiving device 372 to determine an indication of source decoding outcome are explained later. The indication of source decoding outcome may alternatively be referred to as feedback. In a variation, feedback may be transmitted that is not necessarily an indication of source decoding outcome, e.g. a NACK where it is not clear whether the NACK is because channel decoding failed, source decoding failed, or both channel decoding and source decoding failed.

At step 440, the transmitting device 352 receives the indication of source decoding outcome. In response to receiving the indication of source decoding outcome, at step 442 the transmitting device 352 transmits, in a second transmission, a second set of the source encoded bits. The second set of the source encoded bits includes some or all of the source encoded bits that were generated at step 432.

At step 444, the receiving device 372 receives the second set of source encoded bits in the second transmission.

The first transmission may be an initial transmission, and the second transmission may be a retransmission, although it could be the case that the first transmission and the second transmission of are both retransmission (e.g. a first retransmission and a second retransmission).

The source encoding in step 432 performs compression of information to generate the source encoded bits. The source encoding may be in the physical layer. The source encoding may be based on a source compression method that performs either lossless or lossy compression, depending upon the embodiment. In some embodiments, the source compression method implements one of: Lempel-Ziv-Welch (LZW), or principal component analysis (PCA), or integer multiwavelet transform (IMWT), or compression with reversible embedded wavelets (CREW), or discrete cosine transform (DCT).

In some embodiments, the source encoding in step 432 is encoding of information originating from a higher layer of the network. Regardless of whether or not there was some sort of separate compression method at the higher network layer, there may still be the source encoding applied, e.g. in the physical layer. In some embodiments, the source encoding may be applied to information generated locally and/or at a lower layer of the network. For example, future applications or use scenarios (e.g. 6G wireless communication) may involve information (e.g. traffic) resulting from sensing or artificial intelligence (AI) that allows and/or requires real-time or physical source coding and transmission (possibly with channel coding). Example scenarios may include sensing data/image transmission for network control, local AI data/model transmission, quality of service (QOS) based extended reality (XR) and virtual reality (VR) services, etc. The information associated with these scenarios may be source encoded.

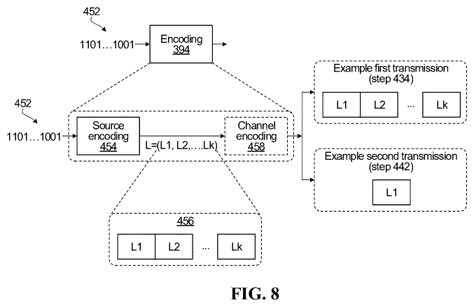

The second set of the source encoded bits transmitted at step 444 may be the same as or different from the first set of the source encoded bits transmitted at step 434. In some embodiments, the second set of the source encoded bits includes only a subset of the source encoded bits transmitted in the first transmission. For example, FIG. 8 illustrates an example of transmission of source encoded bits, according to some embodiments. The transmitting device 352 has information 452 to send to the receiving device 372. Encoding 394 is performed, which includes at least source encoding 454 to result in source encoded bits. The source encoded bits are compressed and so may alternatively be referred to as source compression bits. In the illustrated example, the source encoded bits are L bits consisting of k (k>1) different portions. The portions may be referred to as blocks or source compression blocks. The terms “portions” and “blocks” are used herein interchangeably. There are k blocks L1 to Lk, as shown in stippled bubble 456. The blocks L1 to Lk encompass all or a subset of source encoded bits. In some embodiments, one, some, or all of the blocks L1 to Lk may each be associated with a source encoded bit stream. After source encoding 454, channel encoding 458 such as generation of FEC parity bits may optionally be performed, which is why the channel encoding 458 is shown using stippled lines. In one example, the first transmission in step 434 of FIG. 7 may include all of the source encoded bits (blocks L1 to Lk), and the second transmission in step 442 of FIG. 7 may include only a subset of the source encoded bits, e.g. just block L1. For example, the indication of source decoding outcome sent from the receiving device 372 may indicate that at least block L1 should be retransmitted, e.g. because block L1 is of higher priority for source decoding.

Returning to FIG. 7, the second transmission carrying the second set of the source encoded bits is transmitted in step 442 subsequent to receiving the indication of source decoding outcome, e.g. in response to receiving the indication of source decoding outcome. The indication of source decoding outcome is implementation specific. Examples are included herein, including a few below.

In some embodiments, the receiving device 372 receives the first set of the source encoded bits in step 436 and uses the bits to perform source decoding. Upon completion of source decoding, an amount of distortion in the source decoded bits is measured. The indication of source decoding outcome may be based on a source decoding distortion level. In one example, the indication of source decoding outcome may be a value representing an amount of distortion, which may be used by the transmitting device 352 to determine whether a retransmission of source encoded bits in a second transmission is necessary. In another example, the indication of source decoding outcome may be based on a distortion threshold. For example, if the measured distortion in the source decoded bits exceeds a particular threshold of distortion, a negative acknowledgement (NACK) is sent from the receiving device 372 back to the transmitting device 352, which prompts the receiving device 372 to perform the second transmission at step 442. The NACK pertains to the source decoding outcome, not a NACK related to channel decoding. The NACK is an example of an indication of source decoding outcome.

Any known method for measuring distortion may be used by the receiving device 372 to measure the distortion in source decoded bits. The distortion measure may be a mathematical quantity that specifies how close the source decoded outcome is to the original prior to source encoding. For example, the information source encoded in step 432 may include a portion that is known to both the transmitting device 352 and the receiving device 372, which will be referred to as a pilot. The pilot may be included in the first set of source encoded bits transmitted at step 434 and received at step 436. The receiving device 372 may perform source decoding and then compare the source decoded pilot to the known original pilot to determine the level of distortion. In some embodiments, lossy compression with a distortion level is implemented at the encoding side, which may lead to a trade-off of transmission rate versus distortion. In one embodiment, a codeword set in the source coding space may be defined or configured for the compression within a distortion (mapping to the closest codeword from a lossless compression point). As a result, at the receiving device 372, the source decoding procedure may use the codeword set in the coding space to estimate the distortion level. For channel error-free transmission (e.g. because of FEC), for lossy compression the distortion levels are the same at the source encoding side and the source decoding side, while for a transmission with an erroneous channel (i.e. one or more errors introduced during transmission and not corrected), the distortion levels are different at the source encoding side and the source decoding side, so reporting the distortion level (or an indication based on a distortion threshold) back to the transmitting device 352 may provide some information prompting the second transmission in step 442 and/or providing an indication of what source encoded bits should be transmitted or retransmitted in the second transmission in step 442. In some implementations, the distortion metric might not show a complete picture, and can be combined with CRC detection situations for better feedback, especially in real channel conditions. For example, an estimated distortion at the receiving device 372 may be smaller than the lossless distortion encoding at the transmitting device 352 due to channel errors, which means some portion of the compressed bits are subject to detection/decoding errors, which may be captured by CRC.

Examples of an indication of source decoding outcome based on a source decoding distortion level are explained above. Alternatively, or additionally, at least one cyclic redundancy check (CRC) value may be included in the first transmission transmitted in step 434 and received in step 436, and the indication of source decoding outcome may be based at least in part on a CRC check using the CRC value. A CRC value is a check value computed for a group or block of bits prior to transmission based on the remainder of a polynomial division of their contents. The CRC check after transmission repeats the computation of the check value on the received contents, and if the check value computed does not match the check value received, the CRC check has failed. That is, there is an error in the bits. It may be said that the detection/decoding failed (where in this context “detection” and “decoding” are used interchangeably). In one example, the transmitting device 352 computes a CRC value using the first set of source encoded bits, and the CRC value is included in the first transmission sent at step 434. The receiving device 372 receives, at step 436, the first set of source encoded bits and CRC value. The receiving device 372 performs a CRC check using the CRC value. If the CRC check fails, then the receiving device 372 sends feedback at step 438, e.g. a NACK, which is the indication of source decoding outcome. In another example, the transmitting device 352 transmits a respective CRC value for each portion of a plurality of portions of the source encoded bits transmitted in the first transmission. For example, portions L1 to Lk, referred to as blocks, may be transmitted in the first transmission (like in the FIG. 8 example). Each block L1 to Lk may include a respective CRC value that was computed based on the source encoded bits in that block. The indication of source decoding outcome may indicate at least that a particular block failed decoding based on a CRC check using the respective CRC value corresponding to the particular block. For example, the receiving device 372 may perform a CRC check on each received block L1 to Lk and feedback, to the transmitting device 352, an indication of which blocks failed the CRC check. The indication that a portion/block failed based on a CRC check is an example of an indication of source decoding outcome. Note that in the foregoing examples, the CRC check is performed on the received source encoded bits, not the corresponding source decoded bits. However, it is still an indication of source decoding outcome because it indicates an error in the bits subject to the source decoding. When the source decoding is completed, the error carries through. In some embodiments, instead of or in addition to a CRC value for each portion/block of source encoded bits, there may be a single CRC value computed for the transmitted bits as a whole, e.g. all of blocks L1 to Lk transmitted in the first transmission may be used to compute a CRC value that is also transmitted and used to perform a CRC check. If the CRC check fails, feedback (e.g. a NACK) is transmitted back from the receiving device 372 as the indication of source decoding outcome. Instead of or in addition to any of the foregoing CRC embodiments, the information prior to source encoding in step 432 may be used to compute a CRC value, which is included as part of the information and also source encoded. After source decoding is performed on the receiving device 372, a CRC check is performed using the CRC value and if it fails then feedback (e.g. a NACK) may be sent as the indication of source decoding outcome.

In some embodiments, in the case of lossless compression, if the first transmission sent in step 434 includes CRC protection using one or more CRC values, then upon receiving the first transmission at step 436, the receiving device 372 may first check the CRC, and if failed, send feedback (e.g. a NACK) to the transmitting device 352, which acts as the indication of source decoding outcome. In some embodiments, in the case of lossy compression, the CRC check might be optional. Whether the CRC check is included or not, it may be necessary to estimate the distortion level of the source decoded first transmission, and report feedback accordingly, e.g. send a NACK as the indication of source decoding outcome if the distortion in the source decoded bits is too high. In some embodiments, if there is no CRC protection, then the first transmission received at step 436 is source decoded and a distortion level of the source decoded bits is estimated. An indication of source decoding outcome is reported, e.g. a NACK if the distortion is too high. In some embodiments, if lossy compression is implemented then some distortion in the source decoded bits may be tolerated up to a certain threshold, whereas for lossless compression perhaps none or only a little amount of distortion may be tolerated.

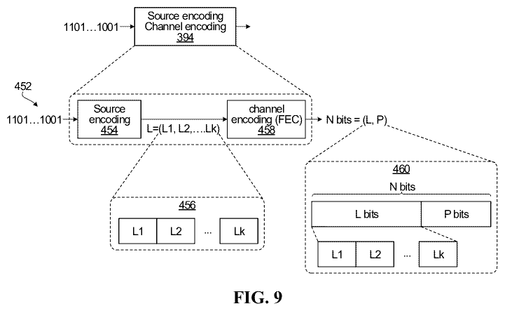

In some embodiments, the method of FIG. 7 may include performing FEC channel encoding to generate parity bits. A first set of the parity bits may be transmitted in the first transmission and a second set of the parity bits may be transmitted in the second transmission. For example, FIG. 9 illustrates a variation of FIG. 8 in which the blocks L1, L2, . . . , Lk are channel encoded 458 to result in N bits. As shown in stippled bubble 460, the N bits include the original L source encoded bits, referred to as the systematic bits, as well as P redundancy bits, referred to as the parity bits. In some embodiments, each of blocks L1 to Lk may each include a CRC value that can be used by the receiving device 372 to determine if, after the FEC using the received parity bits, there are any blocks still having errors. Feedback indicating one or more blocks in error may be the indication of source decoding outcome.

A first set of parity bits may be transmitted in the first transmission at step 434, and a second set of parity bits may be transmitted in the second transmission at step 442. In general, the first set of parity bits may be the same as or different from the second set of parity bits.

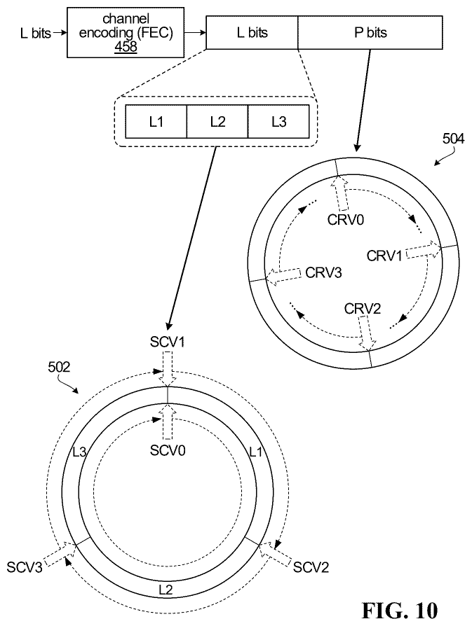

In some embodiments of the method of FIG. 7 in which FEC is implemented, the FEC channel encoding may be performed on all of the source encoded bits (e.g. all L bits in FIG. 9) to generate the parity bits (e.g. all P bits in FIG. 9). Then, the first set of the parity bits sent in the first transmission in step 434 and the second set of the parity bits sent in the second transmission in step 442 may each be different subsets of the parity bits. An example is described later in relation to FIG. 10 in which there are different code redundancy versions (CRVs), but that example is not limiting, e.g. there does not necessarily have to be different source compression versions (SCVs) and CRVs and/or there does not necessarily have to be different blocks of the L bits having different levels of priority.

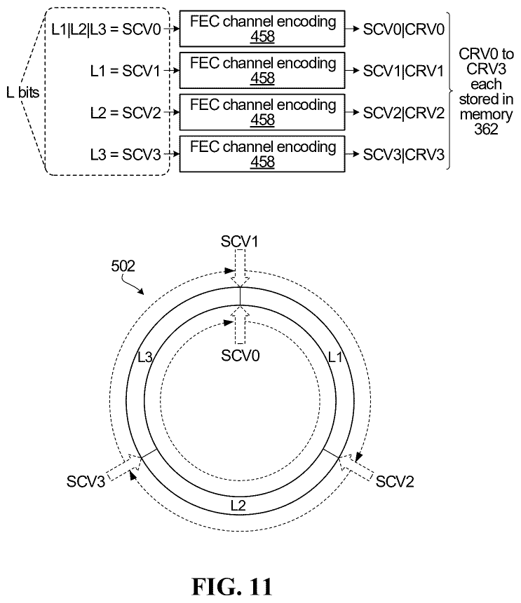

In some embodiments of the method of FIG. 7 in which FEC is implemented, the FEC channel encoding is performed on the source encoded bits transmitted in the first transmission to generate the first set of parity bits that are also transmitted in the first transmission in step 434. The FEC channel encoding is separately performed on the source encoded bits transmitted in the second transmission to generate the second set of parity bits that are also transmitted in the second transmission in step 442. An example is described later in relation to FIG. 11 in which there are different CRVs each corresponding to a FEC encoding of a respective different block of source encoded bits. However, the example is not limiting, e.g. the different blocks of the L bits do not necessarily have to have different levels of priority.

In some embodiments of the method of FIG. 7 in which FEC is implemented, the number of parity bits transmitted in the first transmission and/or the second transmission may vary depending upon at least one of: (i) an allocated time-frequency resource, (ii) a channel coding rate, or (iii) a modulation scheme. For example, a time-frequency resource may be allocated for a transmission of source encoded bits and parity bits (e.g. for transmission of the first transmission or the second transmission in FIG. 7). The allocated time-frequency resource is first used to transmit the source encoded bits, and then the remainder of the allocated time-frequency resource is used to transmit parity bits, with the number of parity bits transmitted dependent upon how much allocated time-frequency resource is left given a particular channel coding rate and/or modulation scheme (e.g. for a given MCS).

In some embodiments of the method of FIG. 7, the source encoded bits comprise a plurality of portions. The portions may be referred to as blocks. An example is FIGS. 8 and 9 introduced earlier in which the L source encoded bits comprise k blocks. The k blocks are shown as non-overlapping, but in general there might be some overlapping of the different blocks. As also discussed earlier, in some embodiments each block L1 to Lk may be individually CRC protected by a respective CRC value that is include as part of the block, such that in some embodiments the receiving device 372 is able to feedback more specifically which block(s) is/are detected in error.

Although not necessary, in some embodiments at least two of the blocks may have different levels of priority. For example, at least two of the blocks may have different levels of priority for transmission, where the at least two blocks may be of different significance at least to the source decoding role, such that in the presence of a limited transmission resource, a block with a higher priority will be transmitted in or may use the limited transmission resource. In some embodiments, the blocks L1 to Lk might possibly each have a different level of priority. In some cases, the source encoded bits may be partitioned into blocks based on their priority, with the number of blocks equal to the number of priority levels, e.g. if there are only “high priority” source encoded bits and “normal priority” source encoded bits, there may be two blocks (k=2): one block (e.g. L1) including all of the high priority source encoded bits and another block (e.g. L2) including all of the normal priority source encoded bits. In some embodiments, the different levels of priority of different blocks may be configured, e.g. by a network via a TRP using dynamic signaling (e.g. DCI) or semi-static signaling (e.g. RRC signaling). In some embodiments, the different levels of priority may pertain to different levels of priority for initial and/or retransmission. For example, a block deemed higher priority may be a block that should be favoured for retransmission.

In some embodiments, the different levels of priority may be associated with different levels of importance to source decoding. For example, a high priority block may carry bits that are important to or maybe even required for the source decoding. The following are some example implementations in which the source encoding 454 produces source encoded bits having at least one portion/block of higher priority:
The Lempel-Ziv-Welch (LZW) algorithm, in which the source encoded output includes an initialized table needed to perform the source encoding and decoding. The block L1 may be the initialized table needed to source decode the remaining blocks L2 to Lk. The block L1 is therefore of higher priority. Therefore, in some embodiments of the method of FIG. 7, the source encoding implements LZW encoding, and a particular portion/block of the source encoded bits having a higher level of priority includes bits representing all or part of a code table used for source decoding.
The compression with reversible embedded wavelets (CREW) algorithm, in which the source encoded bits includes a transform reference signal r(n) and detail signal d(n) needed to perform the decoding. The significance of r(n) and d(n) to the decoding may be different. In one example, r (n) and/or d(n) is included in source block L1 and required for decoding the remaining blocks L2 to Lk. The block L1 is therefore of higher priority. In some embodiments of the method of FIG. 7, the source encoding implements CREW, and a particular portion/block having a higher level of priority includes bits representing a reference signal r(n).
The principal component analysis (PCA) algorithm, in which there are eigenvectors with descending significance order and energy compact information used for decoding. The energy compact information may be included in a block of higher significance, e.g. L1. Therefore, in some embodiments of the method of FIG. 7, the source encoding implements PCA, and a particular portion/block having a higher level of priority includes bits representing one or more eigenvectors each having an associated higher eigenvalue.
The discrete cosine transform (DCT) algorithm, e.g. for compressing image/video, in which different source encoded blocks have different energy/information, such that some blocks (e.g. L1) may be of higher significance. Therefore, in some embodiments of the method of FIG. 7, the source encoding implements DCT, and a particular portion/block having a higher level of priority includes bits of higher energy compacted data points.
The integer multiwavelet transform (IMWT) algorithm, e.g. for compressing images, in which a higher priority block may represent a particular sub-band. Therefore, in some embodiments of the method of FIG. 7, the source encoding implements IMWT, and a particular portion/block having a higher level of priority includes bits representing a particular sub-band.

In one example, block L1 is the highest priority block in that it includes the most important information for source decoding, e.g. block L1 may be an initialized table in an LZW encoding scheme. L2 may be the second highest priority block, L3 may be the third highest priority block, . . . , and Lk may be the lowest priority block. A higher priority block (e.g. the block L1) may include more important information for source decoding, which may be transmitted with a higher priority compared to a lower priority block (e.g. the block Lk), if such a higher priority block has been detected in error by the receiving device 372. For example, L1 may have a more important role for source decoding than the other blocks L2, . . . , L3 (e.g., like in LZW, CREW), or L1 may includes energy compact information (i.e., more information) important for decoding (e.g., like in PCA, DCT). A block may be detected in error at the receiving device 372 if, for example, a CRC check using a CRC value associated with that block indicates an error. Feedback to the transmitting device 352 indicating that error is an example indication of source decoding outcome.

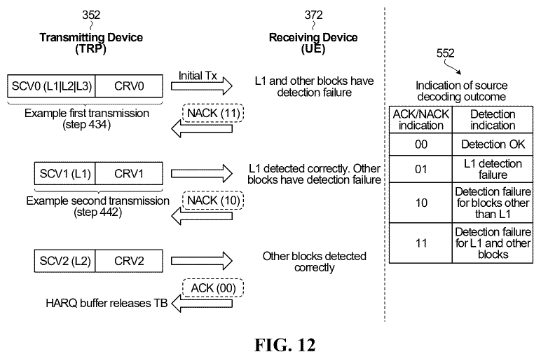

In some embodiments, the first transmission in the method of FIG. 7 includes some or all of the portions/blocks of the source encoded bits, and the indication of source decoding outcome indicates at least that a particular portion sent in the first transmission failed decoding. For example, a NACK may be accompanied by, be, or include feedback indicating which of the different portions failed decoding, and/or the NACK may indicate that at least the particular portion failed decoding. Note that “NACK” as used herein may be a binary indication (e.g. a single bit value indicating the failure, such as a single ACK/NACK bit, where one value of the bit is the NACK). Alternatively, a NACK may be or include information related to the failure, e.g. the indication of which of the different portions failed decoding. When a particular portion fails decoding, that particular portion may then be retransmitted in the second transmission. The particular portion may have a higher level of priority than one or more other portions. The second transmission might include only a subset of the portions sent in the first transmission. One example is as follows. Blocks L1 to Lk are transmitted in the first transmission. The indication of source decoding outcome indicates that at least L1 failed decoding. The “decoding” failed may be channel decoding, source decoding, or a combination of both. For example, block L1 may fail a CRC check, meaning that there is one or more errors in block L1, such that the source decoding would be performed on a block with errors. The source decoding may be considered to have failed in this situation, particularly if it is lossless compression. As another example, the block L1 may be source decoded and the distortion in the source decoded bits indicates that at least block L1 failed source decoding. In either instance, a NACK may be sent back to the transmitting device 352, where the NACK indicates that at least block L1 failed and the NACK is an example of the indication of source decoding outcome. In response, L1 is retransmitted in the second transmission. Block L1 may be higher priority than the other blocks. In this example, the “particular portion” that failed decoding is block L1, block L1 is retransmitted in the second transmission, block L1 is higher priority than another block, and the second transmission only includes a subset of that sent in the first transmission because only L1 is transmitted in the second transmission whereas the first transmission included all of blocks L1 to Lk. Other examples are explained below in relation to FIGS. 12 to 15 in which L1 to Lk is sent in the initial transmission (an example of the first transmission in FIG. 7), and only L1 is sent in the retransmission (an example of the second transmission in FIG. 7).

In some embodiments, source compression versions (SCVs) may be utilized for the first and second transmissions of FIG. 7, possibly along with code redundancy versions (CRVs) if FEC channel encoding is performed.

A CRV is a set (possibly a subset) of parity bits generated from the FEC channel encoding. Each CRV may be defined to have a starting location within a larger set of the parity bits. The CRV length (in terms of number of parity bits in the CRV) might be fixed, or instead it might vary dependent on the allocated time-frequency resource for the transmission and the coding rate and/or modulation scheme (e.g. the MCS value of the link adaptation). In some embodiments, e.g. in the example below in relation to FIG. 10, FEC may be performed on all the source encoded bits to generate parity bits, and each CRV may correspond to a respective set or subset of the parity bits. In other embodiments, e.g. in the example below in relation to FIG. 11, a CRV may correspond to parity bits generated by applying FEC to a particular SCV.

An SCV may be all or a subset of source encoded bits, each version being defined with a starting location and bit length, which defines the source encoded bits in the SCV to be transmitted by the transmitting device 352 in a transmission. In some embodiments, one SCV is associated with one or more portions/blocks L1 to Lk. In some embodiments, upon receiving feedback indicating detection failure from the receiving device 372, and/or upon receiving a scheduling signaling message (e.g. scheduling grant from a TRP), incremental or/and diversity information may be re-transmitted with at least one of a SCV and a CRV to the receiving device 372. In some embodiments, for grant-free transmissions, an initial SCV version and re-transmission SCV version may be predefined for K-repetition (K>1) transmissions without requiring waiting for feedback for each transmission, or for up to K-repetition (K>1) transmissions until an ACK feedback is received from the receiving device 372.

In some embodiments, one SCV may include or be associated with one or more blocks from the L source encoded bits (or one or more segments over the L bits). In some embodiments, a HARQ method (or HARQ-like method) may manage a specific SCV and parity bit redundant version (e.g. CRV) for transmission/retransmissions. In some embodiments, feedback may be based on one or both of: source decoding outcome, e.g. detection failure on one or more blocks is reported or fed back to the transmitter end; and/or channel decoding outcome. In some embodiments, a default SCV can be predefined or configured for the first transmission in the method of FIG. 7.

FIG. 10 illustrates SCVs and CRVs used for multiple transmissions, according to some embodiments. The transmitting device 352 has information to send to the receiving device 372. The information is compressed by source encoding to result in L source encoded bits. These L source encoded bits may be, for example, a compressed transport block (TB), e.g. carrying traffic such as a text or an image, a measurement report, sensing data, AI data or parameters, etc. The L source encoded bits output from the source encoding consist of three portions, referred to as blocks: L1, L2, and L3. FIG. 10 can be thought of as continuing the example of FIG. 9 with k=3. k=3 is just an example. k may instead be other integer values greater than one. The L compression bits undergo FEC channel encoding 458 to result in N bits consisting of the three blocks L1, L2, and L3 as the systematic bits, and P parity bits. The three blocks L1, L2, and L3 are stored in a first circular buffer 502, e.g. in memory 362 of the transmitting device 352. Four SCVs are associated with the circular buffer 502: SCV0 consisting of all of the blocks L1, L2, and L3; SCV1 consisting of block L1; SCV2 consisting of block L2; and SCV3 consisting of block L3. Each SCV is defined/configured with a staring location in the circular buffer 502 and a length encompassing the source encoded bits in the buffer 502 that are part of that SCV. If the blocks have different priority levels (e.g. different significance to the source decoding), a transmission priority may be defined/configured for at least one SCV associated with a respective block, where that SCV includes at least the respective block (or part of it). In the example in FIG. 10 it will be assumed that the three blocks have different priority levels corresponding to different significance/importance to decoding, where L1 is the highest priority and L3 has the lowest priority.

The P parity bits are stored in a second circular buffer 504, e.g. in memory 362 of the transmitting device 352. Four CRVs are associated with the circular buffer 504: CRV0 consisting of a first subset of the P parity bits; CRV1 consisting of a second subset of the P parity bits; CRV2 consisting of a third subset of the P parity bits; and CRV3 consisting of a fourth subset of the P parity bits. Because the P parity bits are generated from all L source encoded bits (i.e. all L bits are input into the FEC channel encoding 458 to generate the P parity bits), it may be that each parity bit equally protects each and every source encoded bit. A CRV is a subset of the parity bits, and different CRVs are incremental parity bits.

The transmitting device 352 uses the defined SCVs and CRVs to try to transmit the information more reliably via HARQ-like feedback based on the SCVs and CRVs, possibly also trying to enhance spectrum efficiency by using fewer transmission resources, e.g. on time-varying channels. Each transmission may consist of a SCV and/or a CRV. In one embodiment, each block L1 to L3 has included therein its own CRC value to allow for a CRC check on a block-by-block basis at the receiving device 372 to determine which blocks did and did not fail decoding. In some embodiments, the initial transmission and retransmission(s) may be implemented as follows:
An initial transmission to receiving device 372 over channel 390 includes SCV0 (i.e. all L compression bits) and CRV0 (i.e. the first subset of the parity bits). The initial transmission may be, for example, the first transmission in step 434 of FIG. 7.
If the CRC check fails on block L1, then feedback may be provided to the transmitting device 352. The feedback is an example of the indication of source decoding outcome referenced in the method of FIG. 7.
In response to receiving the feedback, the transmitting device 352 may send a retransmission including SCV1 and CRV1. Even if other blocks failed their respective CRC checks, the bits of the retransmission include only SCV1 because the SCV1 bits correspond to L1, which is the highest priority. By transmitting fewer bits in a retransmission (e.g. only including SCV1 and CRV1 not additionally SCV2), transmission resources may be saved. The retransmission may be, for example, the second transmission of step 442 of FIG. 7.
If the CRC check for block L1 did not fail, but it did fail on block L2, then a retransmission is sent including SCV2 and CRV2. Even if the CRC check for block L3 also failed, the bits of the retransmission include only SCV2 because the SCV2 bits correspond to L2, which is higher priority than L3. By transmitting fewer bits in a retransmission (e.g. only including SCV2 and CRV2 not additionally SCV3), transmission resources may be saved.
If the CRC check did not fail on block L1 or L2, but did fail on block L3, then a retransmission is sent including SCV3 and CRV3. The SCV3 bits correspond to L3.

In the method above, the source decoding for a block of higher priority may be improved because retransmission of bits associated with that block are favoured. For example, if block L1 fails the CRC check at the receiving device 372, then a retransmission is sent consisting of SCV1+CRV1, even if other blocks L2 and/or L3 also failed their respective CRC check. Incremental redundancy (IR) channel decoding may be performed. In particular, once SCV1+CRV1 is received in the retransmission, the bits of L1 in the initial transmission may be combined with (e.g. added to) the same bits of L1 in SCV1 (e.g. to get 3 dB gain in SNR for L1 bits), and the parity bits of CRV1 complement the bits of CRV0 already received providing more parity bits, thereby increasing the chance that L1 is channel decoded correctly. If L1 is channel decoded correctly it passes the CRC check and is error free for source decoding.

In the example illustrated in FIG. 10, the circular buffer 504 storing the parity bits has four CRVs defined that each encompass a respective different subset of bits. The starting point of each CRV in the buffer 504 is defined/configured, but the ending point of each CRV (i.e. the bit length of each CRV) varies and is dependent upon the allocated time-frequency resource and/or channel coding rate and/or modulation. For example, an allocated time-frequency resource for a transmission is first used by the SCV (which has a defined and configured length), and then the remainder of the allocated time-frequency resource is used by the corresponding CRV with possible varying bit length to rate match on the allocated time-frequency resource given the channel coding rate and/or modulation scheme. For example, if a retransmission includes SCV1+CRV1, all of SCV1 will be transmitted, but the end point of CRV1 (i.e. how many parity bits in CRV1) will be a function of the remainder of the allocated resource having regard to the coding rate and/or modulation scheme. CRV1 may have only a few bits, or it may have a large number of bits. More generally, for any CRVi (i=0,1, . . . ) in any of the embodiments having CRVs, the start position of the CRV may be configured or predefined, but its bit length (or end position) may be a function of the remainder of the allocated resource having regard to the coding rate and/or modulation scheme. In situations in which the allocated time-frequency resource is limited, part of the SCV might only be transmitted and/or the corresponding CRV might not be transmitted. In other embodiments, each CRV may be a fixed length and correspond to a respective subset of parity bits. When a CRV is to be transmitted, the whole CRV length is transmitted. In embodiments in which each CRV includes a respective non-overlapping subset of parity bits, a circular buffer need not be implemented, e.g. the bits of each CRV can just be stored in memory. More generally, any embodiment herein in which a circular buffer is illustrated, an alternative implementation might not actually use a buffer that is circular.

In FIG. 10, each CRV is a respective different subset of the P parity bits output from the FEC channel encoding of the L compression bits. In a variation shown in FIG. 11, each CRV is instead some or all of the parity bits output from the FEC channel encoding of a respective corresponding SCV. For example, CRV0 is all or some of the parity bits output from FEC channel encoding SCV0, CRV1 is all or some of the parity bits output from FEC channel encoding SCV1, CRV2 is all or some of the parity bits output from FEC channel encoding SCV2, and CRV3 is all or some of the parity bits output from FEC channel encoding SCV3. This may offer stronger protection for individual blocks, e.g. for when retransmitting a block having a higher level of priority. For example, if SCV0+CRV0 is transmitted in the initial transmission (e.g. the first transmission of FIG. 7) and the CRC check for block L1 fails such that SCV1+CRV1 is retransmitted (e.g. in the second transmission of FIG. 7), the CRV1 parity bits are dedicated to protecting block L1, thereby increasing the probability of block L1 having a successful CRC check so that it is error free for the source decoding. In some embodiments, CRV1, CRV2, and/or CRV3 each have a lower coding rate (more redundancy) than CRV0 to further increase the probability of successful decoding when there is a retransmission. The CRVs do not need to be stored in a circular buffer because they are each an independent set of bits. They instead may be stored in a regular buffer or other allocation of memory 362.

In some embodiments, the initial transmission and retransmission(s) may be implemented as follows in FIG. 11:
An initial transmission to receiving device 372 over channel 390 includes SCV0 (i.e. all L compression bits) and CRV0 (i.e. parity bits from the FEC encoding of SCV0). The initial transmission may be, for example, the first transmission in step 434 of FIG. 7.
If the CRC check fails on block L1, then feedback may be provided to the transmitting device 352. The feedback is an example of the indication of source decoding outcome referenced in the method of FIG. 7.
In response to receiving the feedback, the transmitting device 352 may send a retransmission including SCV1 and CRV1. Even if other source blocks failed their respective CRC checks, the bits of the retransmission include only SCV1 because the SCV1 bits correspond to L1, which is the highest priority. CRV1 are parity bits based on FEC encoding of SCV1. By transmitting fewer bits in a retransmission (e.g. only including SCV1 and CRV1 not additionally SCV2), transmission resources may be saved. By transmitting parity bits based directly on SCV1, then SCV1 may possibly be better protected. The retransmission may be, for example, the second transmission of step 442 of FIG. 7.
If the CRC check for block L1 did not fail, but it did fail on block L2, then a retransmission is sent including SCV2 and CRV2. Even if the CRC check for block L3 also failed, the bits of the retransmission include only SCV2 because the SCV2 bits correspond to L2, which is higher priority than L3. CRV2 are parity bits based on FEC encoding of SCV2. By transmitting fewer bits in a retransmission (e.g. only including SCV2 and CRV2 not additionally SCV3), transmission resources may be saved. By transmitting parity bits based directly on SCV2, then SCV2 may possibly be better protected.
If the CRC check did not fail on block L1 or L2, but did fail on block L3, then a retransmission is sent including SCV3 and CRV3. The SCV3 bits correspond to L3.

Incremental redundancy (IR) channel decoding may be performed. For example, once SCV1+CRV1 is received in the retransmission, the bits of L1 in the initial transmission may be combined with (e.g. added to) the same bits of L1 in SCV1 (e.g. to get 3 dB gain in SNR for L1 bits), and the parity bits of CRV1 complement the bits of CRV0 already received providing more parity bits, thereby increasing the chance that L1 is channel decoded correctly. If L1 is channel decoded correctly it passes the CRC check and is error free for source decoding.

Just like in the FIG. 10 example, in the embodiment explained in relation to FIG. 11 the bit length of each CRV may vary and be dependent upon the allocated time-frequency resource having regard to the channel coding rate and/or modulation scheme. An allocated time-frequency resource for a transmission is first used by the SCV (which has a defined and configured length), and then the remainder of the allocated time-frequency resource is used by the corresponding CRV with possible varying bit length to rate match on the allocated time-frequency resource given the channel coding rate and/or modulation scheme. When the SRV is FEC channel encoded to generate a particular number of parity bits, the CRV may be the subset of those parity bits that matches the available time-frequency transmission resources for the given channel coding rate and/or modulation scheme. In situations in which the allocated time-frequency resource is limited, part of the SCV might only be transmitted and/or the corresponding CRV might not be transmitted.

FIG. 12 illustrates an example source coding retransmission protocol using the SCVs and CRVs defined in either FIG. 10 or FIG. 11. In the example in FIG. 12, lossless source coding is assumed, and it is also assumed that the transmitting device 352 is a TRP and the receiving device 372 is a UE. Table 552 provides the options for the indication of source decoding outcome. The values in table 552 are known in advance by both the transmitting device 352 and the receiving device 372, e.g. they are defined or preconfigured in advance. In this example, the indication is based on a CRC check for each block of source encoded bits. If after channel decoding a block passes the CRC check, it is considered a successful detection. i.e. the block is error free for the source decoding. If instead after the channel decoding a block fails the CRC check, it is considered a detection failure for that block because the block has one or more errors, which means source decoding with that block will lead to error/distortion. The four options in table 552 are: 00 for correct detection of all blocks: 01 for if there is detection failure in just block L1; 10 for if there is detection failure for blocks other than L1; and 11 for detection failure of block L1 and other blocks. Block L1 is considered a higher level of priority for the source decoding, and therefore its retransmission is favoured. In the example, the transmitting device 352 has a TB to transmit to the receiving device 372. The TB is source encoded to result in source encoded bits consisting of three blocks L1 to L3. The initial transmission includes SCV0+CRV0. The receiving device 372 uses CRV0 to perform FEC and then performs a CRC check on each of received blocks L1 to L3. L1 and one or more other blocks each fail the CRC check. Therefore, a NACK carrying the value 11 is fed back from the receiving device 372 to the transmitting device 352. In response, the transmitting device transmits SCV1+CRV1. The receiving device 372 receives SCV1+CRV1 and uses HARQ soft-combining such as incremental redundancy (IR) to attempt to channel decode L1 and possibly again attempt to channel decode the other blocks that failed the CRC check. L1 is channel decoded correctly, i.e. the CRC check for L1 did not fail. The other blocks that failed the CRC check still have a detection failure, which is not unexpected since the retransmission focussed on L1. The receiving device 372 sends a NACK carrying the value 10. In response, the transmitting device transmits SCV2+CRV2. This provides enough redundancy to allow for correct channel decoding of the remaining blocks, e.g. using IR decoding. The CRC check has passed for all blocks. An ACK is transmitted, and the transmitting device 352 releases the TB from its HARQ buffer.

In the example in FIG. 12, the initial transmission of FIG. 12 is an example of the first transmission (step 434) of the method of FIG. 7, and the first retransmission of FIG. 12 is an example of the second transmission (step 442) in the method of FIG. 7. The NACK (11) is an example of the indication of source decoding outcome. Alternatively, the first and second retransmissions in FIG. 12 may be examples of the first and second transmissions in FIG. 7, in which case the NACK (10) may be an example of the indication of source decoding outcome.

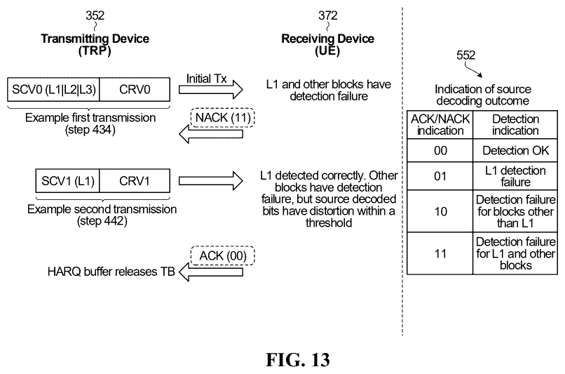

FIG. 13 is a variation of FIG. 12 in which lossy compression is implemented instead of lossless compression. After the first retransmission the receiving device 372 correctly channel decodes high priority block L1. The CRC check for L1 passes. Therefore, source decoding proceeds even though there are one or more other blocks in which the CRC check still fails. There will be distortion in the source decoded bits at least because some of the received source encoded blocks had transmission errors. However, the amount of distortion in the source decoded bits is considered an acceptable level (e.g. below a threshold), and so an ACK is fed back to the transmitting device 352.

In the examples in FIGS. 12 and 13, it is not necessary that CRC checks on the blocks L1 to L3 are used to determine the detection/decoding failure. For example, it could be instead (or in addition) that after FEC the blocks undergo source decoding, it is determined the level of distortion in the source decoded bits, and there is a mapping between distortion in different parts of the source decoded bits and the blocks such that it can be determined by the receiving device 372 which blocks are associated with a detection failure.

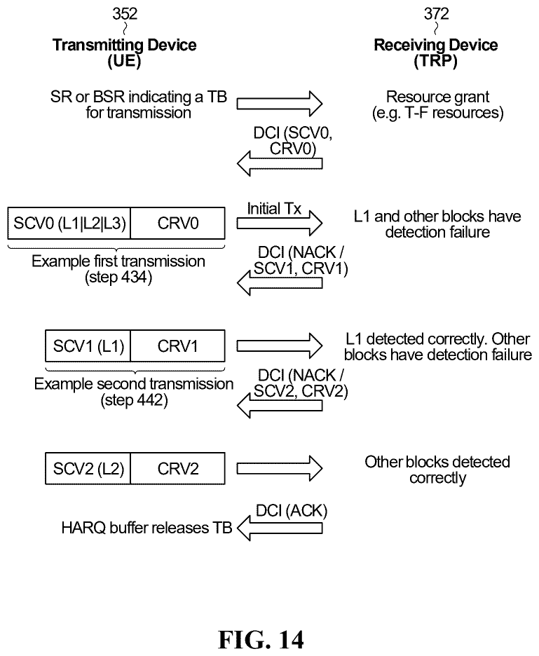

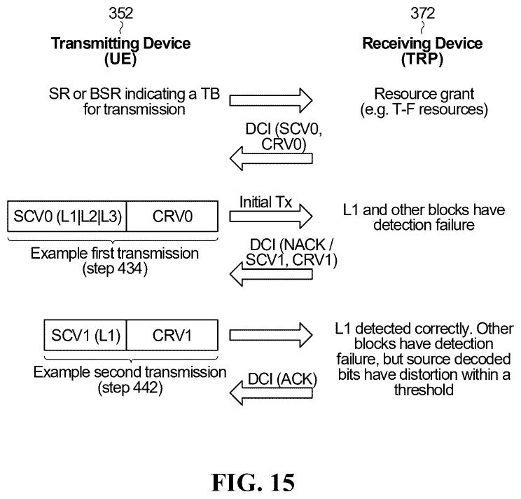

FIG. 14 illustrates another example source coding retransmission protocol using the SCVs and CRVs defined in either FIG. 10 or FIG. 11. In the example in FIG. 14, lossless source coding is assumed, and it is also assumed that the transmitting device 352 is a UE and the receiving device 372 is a TRP, such that the feedback from the TRP may be DCI. The transmitting device 352 has a TB to send, and so the transmitting device 352 transmits a scheduling request (SR) and/or a buffers status report (BSR) that indicates, to the receiving device 372, that there is a TB for transmission. The receiving device grants or activates resources (e.g. time-frequency resources) for the initial transmission and any retransmissions. A DCI is sent to the transmitting device 352 indicating or activating the resource grant and also indicating which SCV and CRV to use. The rest of the method then proceeds the same as FIG. 12, and the explanation and variations discussed above in relation to FIG. 12 apply. In FIG. 14, the DCI does not necessarily have to use and transmit the values from the table 552 (although it could). The DCI may instead explicitly indicate which SCV and CRV to use, which is what is illustrated in FIG. 14. FIG. 15 is the variation for lossy compression, and the remarks and variations discussed in relation to FIG. 13 also apply to FIG. 15.

In variations of FIGS. 8 to 15, the portions/blocks of source encoded bits might have no differentiated levels of priority, e.g. each source encoded bit (or block of bits) may contribute equal information to the source decoding and/or channel decoding. The length of each of SCV1 to SCV3 might or might not be equal. In some such embodiments, the L portions/blocks may be equally divided into three non-overlapping sets, and each one mapped to a respective one of SCV1 to SCV3. Each block may have a respective CRC value to allow for detection failure on a block-by-block basis. If detection failure occurs for a single block, then the SCV corresponding to that block is retransmitted, e.g. if L1 fails then the retransmission includes SCV1. If detection failure occurs for two or more blocks, a selection of one SCV may be: (1) random (e.g. if L1 and L2 fail, then randomly pick SCV1 or SCV2 to retransmit); and/or (2) based on previous retransmission history so that each SCV is transmitted with equal opportunity (e.g. if L1 and L2 fail, then pick SCV2 to retransmit instead of SCV1 if SCV1 was already retransmitted); and/or (3) transmit multiple SCVs while reducing the number of CRV bits if necessary (e.g. if L1 and L2 fail, then retransmit SCV1 and SCV2 reducing or eliminating the CRV bits, assuming there are enough allocated time-frequency resources to transmit both SCV1 and SCV2). In some embodiments, the preceding selection options (1) to (3) may be configured by a network, e.g. using higher-layer signaling such as RRC signaling. In some embodiments, selection of one of the options may be signaled by the network either dynamically (e.g. in DCI) or semi-statically (e.g. in higher-layer signaling such as RRC signaling). In some embodiments, a selection rule may be RRC configured based on certain conditions such as service types or application types. In some embodiments, an initial transmission includes SCV0 and CRV0, where SCV0 includes all the source encoded bits for the transmission to be self-decodable by the receiving device 372 receiving the initial transmission. Upon receiving the initial transmission, the receiving device 372 may perform channel decoding and source decoding, and if decoding failure occurs, one or more blocks may be detected in error, and thus a retransmission is required where a SCV associated with the erroneous block is to be transmitted. The SCV for the retransmission may be selected as explained above. The remaining explanation above in relation to FIGS. 10 to 15 may still apply in the situation of blocks of a same priority level, e.g. the CRVs may be defined as shown in FIG. 10 or 11, and the length of each CRV may be dependent upon the available allocated time-frequency transmission resource having regard to coding rate and/or modulation scheme. In situations in which the allocated time-frequency resource is limited, part of the SCV might only be transmitted and/or the corresponding CRV might not be transmitted.

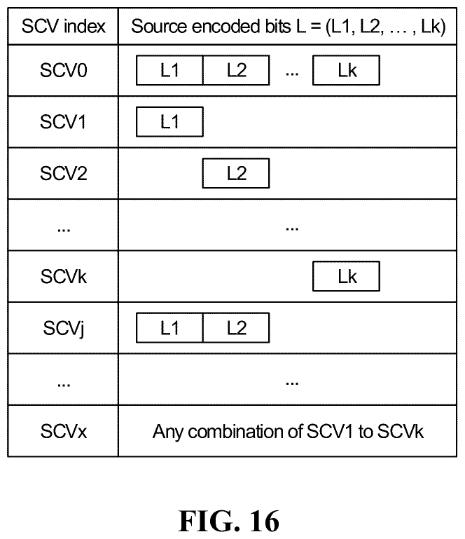

In the examples explained above in relation to FIGS. 10 to 15 and their variations, there are only three portions/blocks of source encoded bits L1 to L3. In general, there may be k blocks, where k is a natural number greater than one. Also, in the examples explained above in relation to FIGS. 10 to 15, the bits of each SCV1 to SCV3 equal the bits of a respective different block, e.g. the bits of SCV1 are the bits of block L1. Alternatively, an SCV might only encompass a portion of bits of a block (e.g. SCV1 might only include some of the bits of L1), or an SCV might encompass bits of a block plus some bits of another block (e.g. SCV1 might include all the bits of L1 and some of the bits of L2), or an SCV might encompass bits of multiple blocks (e.g. SCV1 might include all the bits of L1 and L2). FIG. 16 illustrates one example way in which SCVs may be mapped to different blocks of source encoded bits, where there are k blocks. Note that some SCV indices may map to multiple blocks. In the mapping of FIG. 16, the block L1 might have the highest level of priority, and the block Lk might have the lowest level of priority. Alternatively, the mapping of FIG. 16 might still apply even if all blocks have the same level of priority, e.g. the L bits have equal (or non-differentiated) significance but are still partitioned into blocks to define different subsets of the L bits corresponding to different SCVs.

In the examples explained above in relation to FIGS. 8 to 15 and their variations, the L source encoded bits, or blocks of the L source encoded bits, might include additional information, such as headers and/or soft source information such as a priori source information, and/or marginal source distortion information/acceptable thresholds, etc. In one embodiment, there may be a header in a transmission to indicate, to the receiving device 372, lengths/locations of L1, L2, . . . , Lk, where the header may be like a MAC sub-header to indicate types of context and lengths. In embodiments in which the different blocks have different levels of priority, a header for each block might include a flag to indicate the priority of the block (e.g. two priorities: L for low and H for high). Additionally, or alternatively, the priority of blocks may be put in order (e.g. descending order), such as putting block L1 first if it is the highest priority.

In some embodiments of the method of FIG. 7, the indication of source decoding outcome includes an indication of which of the source encoded bits to send in the second transmission. Examples of this are described in relation to the specific examples of FIGS. 12 to 15. For example, the bits fed back from the receiving device indicating NACK/ACK are examples of an indication of source decoding outcome and indicate explicitly or indirectly which source encoded bits should be sent in a retransmission. In some embodiments of the method of FIG. 7, the indication of which of the source encoded bits to send in the second transmission includes an indication of a SCV to use for the second transmission. For example, in FIGS. 12 and 13, the first transmission of FIG. 7 may be the initial transmission of FIG. 12 or 13, and the second transmission of FIG. 7 may be the first retransmission of FIG. 12 or 13. The indication NACK (11) sent in FIG. 12 or 13 is an indication that SCV1 is to be sent in the second transmission (i.e. the first retransmission of FIG. 12 or 13). The NACK (11) is an indirect indication because it does not explicitly indicate SCV1, but the transmitting device 352 and receiving device 372 both know that in response to a NACK (11), SCV1 should be sent. In another example, in FIGS. 14 and 15, the first transmission of FIG. 7 may be the initial transmission of FIG. 14 or 15, and the second transmission of FIG. 7 may be the first retransmission of FIG. 14 or 15. The indication DCI (NACK/SCV1, CRV1) explicitly indicates that SCV1 should be used for the first retransmission.

In some embodiments, SCVs may exist without CRVs. The first transmission in the method of FIG. 7 may include the source encoded bits corresponding to a particular SCV, and the indication of source decoding outcome may explicitly or indirectly indicate which SCV to use for the second transmission.

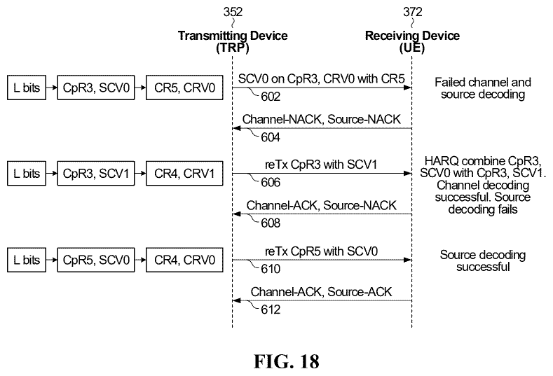

In some embodiments of the method of FIG. 7, the feedback transmitted at step 438 including the indication of source decoding outcome might include one or two feedback messages, e.g. one or two NACKs (or ACKs). If one ACK/NACK is transmitted, an ACK may represent source decoding success, and the NACK may be the indication of source decoding outcome prompting the second transmission. For example, a NACK is transmitted because the source decoded bits have too much distortion and/or a NACK is transmitted because one or more blocks of received source encoded bits failed a CRC check meaning the bits are in error going into the source decoding (e.g. which in lossless compression means a failure of source decoding because the blocks in error are being decompressed by the source decoding). In embodiments in which there are two feedback messages, one might be specific to channel coding and the other may be specific to source coding. For example, step 438 of FIG. 7 may include an ACK or NACK indicating whether the channel decoding failed, e.g. based on a CRC check failing after channel decoding, and step 438 of FIG. 7 may additionally include an ACK or NACK indicating whether the source decoding failed, e.g. based on a measure of distortion in the source decoded bits. FIG. 18 described later shows an example in which there is separate ACK/NACK feedback for source decoding and channel decoding.

In some embodiments, the second transmission in step 442 of FIG. 7 is performed in response to receiving a NACK indicating at least one of unsuccessful source decoding or unsuccessful channel decoding. For example, the NACK may indicate unsuccessful source decoding (e.g. based on too much distortion), which may trigger the second transmission. Or the NACK may indicate unsuccessful channel decoding (e.g. based on a failed CRC check), which may trigger the second transmission. Or the NACK may indicate unsuccessful source and/or channel decoding (e.g. it is not indicated which one was unsuccessful, but at least one was unsuccessful, and it might not even be clear which one if a joint channel and source decoding algorithm is implemented), which may trigger the second transmission.

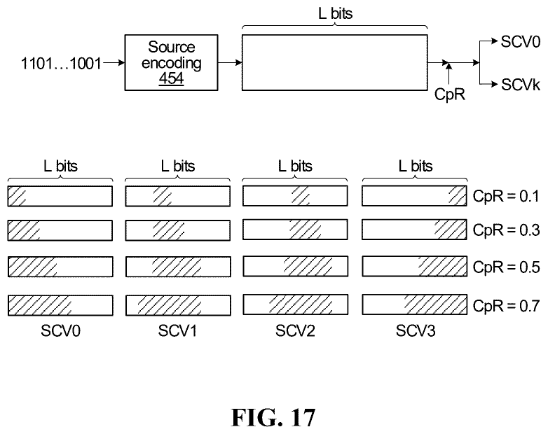

In the specific examples of the method of FIG. 7 discussed in relation FIGS. 8 to 15, the L source encoded bits comprise multiple portions/blocks, e.g. L1 to L3. In a variation, the source encoded bits might or might not comprise multiple portions/blocks, and if the source encoded bits comprise multiple portions/blocks, the different portions/blocks might or might not have different levels of priority. In any case, a SCV might be defined as a subset of the source encoded bits, each at a different starting location, and the length of the SCV may be defined by a compression rate value, referred to as a compression rate (“CpR”). The transmitting device 352 may receive an indication of CpR, which dictates how many bits of a particular SCV to transmit in a transmission (e.g. in the first transmission and/or the second transmission of FIG. 7). For example, FIG. 17 illustrates different example SCV sizes. The information undergoes the source encoding 454 at the transmitting device 352 to obtain L source encoded bits, e.g. as per step 432 of FIG. 7. The L source encoded bits may be stored in a circular buffer. Each SCV is a respective different subset of the L source encoded bits, with a predefined or preconfigured starting point. A CpR defines a length of each SCV and possibly the starting point of one or more of the SCVs (or alternatively the start of each SCV may be fixed, with just the CpR defining the length). An example with k=3 SCVs is illustrated in FIG. 17. The hatching shows the subset of L source encoded bits that is included in each SCV, for each CpR, where four example CpRs are illustrated: 0.1, 0.3, 0.5, and 0.7. FEC channel encoding might additionally be performed to define respective CRVs, e.g. in the way CRVs are generated in FIG. 10 or FIG. 11. For example, each CRV may be a subset of the parity bits generated by FEC channel encoding the L bits (like in FIG. 10), or each CRV may be parity bits from FEC channel encoding a respective SCV (like in FIG. 11) where the SCV may be defined as a function of a CpR like shown in FIG. 17. The example methods of FIGS. 12 to 15 may apply to a SCV generated as shown in FIG. 17, except the SCVs might not necessarily correspond to a block of source encoded bits (e.g. L1 to L3 might not be explicitly defined). In some embodiments in the context of a wireless communication system, a CpR might be defined as part of a modulation and coding scheme (MCS), e.g. to allow for not just link adaptation, but also for adaptation of compression rate. For example, the transmitting device 352 is a UE and the receiving device 372 is a TRP. Instead of the TRP sending an MCS value indicating the MCS for a transmission (e.g. for the first and/or second transmission of FIG. 7), the TRP sends a modulation, CpR, and coding scheme (MCCS) value, which maps to a particular modulation rate, CpR, and coding rate to be used for a transmission (e.g. for the first and/or second transmission). An example MCCS table is as follows:

| MCCS value | Modulation | Coding Rate | CpR |
|---|---|---|---|
| 0 | BPSK | 0.5 | 0.5 |
| 1 | BPSK | 0.5 | 1.0 |
| 2 | QPSK | 0.75 | 0.5 |
| . . . | . . . | . . . | . . . |

In some embodiments, multiple versions of MCCS tables (with different values) may be generated, each being associated with a respective different channel quality metric (such as bit or block error rate), and a particular one of the tables configured to be used.

FIG. 18 illustrates an example method of retransmission in which CpRs are implemented. In the method of FIG. 18, the transmitting device 352 is a TRP, and the receiving device 372 is a UE. The TRP performs source encoding to generate L source encoded bits. The subset of L source encoded bits defined by SCV0 with a particular CpR (referred to as “CpR3”) is selected for initial transmission. FEC channel encoding is performed with a particular coding rate CR (referred to as “CR5”) to obtain CRV0. SCV0 and CRV0 are transmitted at step 602 in an initial transmission. In the example of FIG. 18, the UE separately sends feedback in relation to the channel decoding and the source decoding. In one implementation, channel decoding may be determined to fail as follows: a CRC value is computed for the transmitted systematic bits and after FEC channel decoding using the parity bits if the CRC check using the CRC value fails then the channel decoding is considered to have failed. In one implementation, source decoding may be determined to fail as follows: the received source encoded bits, after channel decoding, are source decoded. The level of distortion in the source decoded bits is compared to a distortion threshold, and if the level of distortion is too high (e.g. exceeds the threshold), then source decoding may be determined to have failed. Alternatively, or additionally, a CRC value may be included in the information prior to source encoding, and if the CRC check fails after source decoding the source decoding may be determined to have failed.

In the example in FIG. 18, it is assumed that the UE fails to successfully perform channel decoding and source decoding on the initial transmission sent in step 602. Therefore, in step 604 the UE feeds back a NACK indicating that channel decoding failed (referred to as a “Channel-NACK”) and the UE also feeds back a NACK indicating that source decoding failed (referred to as a “Source-NACK”). In response, the TRP selects the subset of L bits corresponding to SCV1 with the same compression rate CpR3. The parity bits generated/selected are CRV1, but with a lower coding rate “CR4” to offer more robust channel decoding performance. The SCV1 and CRV1 are transmitted in step 606. The UE performs HARQ combining channel decoding (e.g. incremental redundancy), combining SCV0 with SCV1. In the example, it is assumed that channel decoding now is successful, but source decoding still fails. Therefore, in step 608, the UE feeds back an indication that channel decoding was successful (“Channel-ACK”) and a Source-NACK. In response, the TRP selects a new SCV0 for the L bits defined using a lower compression rate “CpR5”, which means more source encoded bits than SCV0 defined by CpR3. A corresponding CRV0 is obtained using lower coding rate CR4. The SCV0 and CRV0 are transmitted in step 610. The channel and source decoding are successful and so an ACK for each one is transmitted in step 612 (Channel-ACK and Source-ACK).

In the method of FIG. 18, it may be said that link adaptation is performed because the coding rate is changed for the second transmission. It may also be said that compression adaptation is performed because the compression rate is changed for the third transmission. The transmission in step 602 is an example of the first transmission of the method of FIG. 7, the transmission in step 606 is an example of the second transmission of the method of FIG. 7, and the feedback in step 604 is an example of the indication of source decoding outcome.

The examples of CpR described in relation to FIGS. 17 and 18 may be implemented as part of the method of FIG. 7. As an example, and more generally, the method of FIG. 7 may include receiving a compression rate value configuring how many of the source encoded bits are to be transmitted in at least one of the first transmission or the second transmission of FIG. 7. Different compression rate values (CpRs) indicate different subset sizes of the source encoded bits to be transmitted. A SCV may define a starting point of the subset.

In some embodiments of the method of FIG. 7, the indication of source decoding outcome comprises an indication of which of the source encoded bits to send in the second transmission, and the indication of which of the source encoded bits to send in the second transmission is based on processing of artificial intelligence (AI) data. For example, AI data may be transmitted from the transmitting device 352 (e.g. which may be a UE) to the receiving device 372 (e.g. which may be a TRP). Some or all of the AI data itself may be compressed, and/or the AI data may accompany non-AI data that is compressed. The compressed bits may be the source encoded bits transmitted in the first transmission in FIG. 7 in step 434. In one example, the AI data is training data for training an AI model, e.g. for training a machine learning (ML) model such as a neural network (NN). The AI data might include different portions/blocks of different levels of priority, e.g. critical parameters of the AI model may me more important than other secondary data used for supplementing or refining the model. The received AI data may be processed and the processing may reveal that certain data needs to be transmitted or retransmitted, e.g. perhaps additional training data needs to be transmitted or retransmitted for the training of the model to converge. It could be that certain critical training data and/or parameters failed source decoding, measured by a CRC check and/or by a failure in relation to the decompressed data, e.g. the training not converging. The indication of source decoding outcome may indicate what needs to be retransmitted. In some embodiments, the feedback (i.e. the indication of source decoding outcome) might not necessarily just be a NACK, but might be one or more bits providing a more meaningful indication of what needs to be transmitted in the second transmission, e.g. the feedback may be more semantic in nature.

In any embodiments herein in which channel coding is implemented, the channel coding might be separate from the source coding, or instead joint source channel coding (.JSCC) may be implemented. JSCC may enhance performance, e.g. joint LDPC source coding and LDPC channel coding may possibly reach about 2.3 dB gain compared to separate and joint source and channel coding at bit error rate (BER) of 10⁻⁴.

Various signaling may be implemented to support any of the embodiments described herein. Examples may include:
Signaling to configure/define priority of blocks and/or SCVs, e.g. to indicate that block L1 is the highest priority, to indicate the higher priority SCVs useful for joint channel and source decoding, etc.
JSCC dual-level transmission version may be indicated over DCI signaling, e.g. indicating: a SCV and/or a CRV and/or a HARQ process number and/or a new data indicator and/or a source compression rate
ACK/NACK feedback, which may include separate ACK/NACK for channel decoding and/or source decoding (e.g. 1-bit source-ACK/NACK or feedback that provides more information on source decoding failure). This may be the indication of source decoding outcome in FIG. 7.

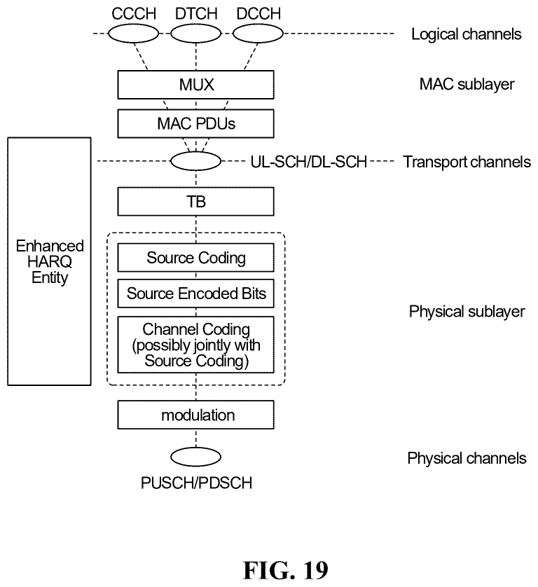

Some additional embodiments will now be described specifically in the context of implementation in a wireless communication. FIG. 19 illustrates a system architecture for wireless communication, according to some embodiments. The information in logical channels, such as in a common control channel (CCCH), dedicated traffic channel (DTCH), and/or dedicated control channel (DCCH), are multiplexed and inserted into medium access control (MAC) packet data units (PDUs). The MAC PDUs are for transmission in an uplink shared channel (UL-SCH) or downlink shared channel (DL-SCH). The information is sent in transport blocks (TBs). In the physical sublayer each TB undergoes the source coding referred to herein (e.g. in step 432 of FIG. 7) to generate source encoded bits, e.g. the L bits referred to herein, which may be partitioned into portions/blocks L1 to Lk. Channel coding is applied, possibly jointly with the source encoding, followed by modulation and transmission on a physical channel such as a physical uplink shared channel (PUSCH) or a physical downlink shared channel (PDSCH). An enhanced HARQ entity may control the feedback/retransmissions of different source encoded bits referred to herein. For example, the HARQ entity may implement the framework for managing the retransmissions so that, for example, the transmitting device knows when it needs to retransmit source encoded bits and the receiving device knows whether a received packet is an initial or retransmission, and if it is a retransmission, the receiving device knows the TB to which the retransmission relates. The HARQ entity may manage MAC PDU fragmentation/defragmentation, transport block buffering and processing, source encoded bits and channel coding bits with management of redundant information transmissions. Optionally, the source coding and/or channel coding can adapt based on feedback on channel quality, e.g. based on channel quality indicator (CQI) values. For example, if a CQI value indicates that the channel is of good quality, then a more aggressive source coding (e.g. fewer source encoded bits) and/or a higher coding rate (less redundancy) may be implemented, and vice versa if the CQI value indicates that the channel is of low quality. Channel-aware source coding (e.g. changing how aggressive the source coding is) may be implemented in addition to normal link adaptation that changes MCS. Instead of a CQI value, another channel metric or metric such as bit error rate or packet error rate may be used to adapt the source coding. The source coding adaption may be implicit (e.g. correlated based on a measure of channel quality) or explicit (e.g. controlled by the network via an explicit message).

The L source encoded bits output from the source encoding may be referred to as a source packet. In some embodiments, different source packets may be multiplexed within a same TB. If a TB has multiple source packets, each source packet in the TB (consisting of compressed bits) may have associated with it a header that indicates the source packet number and possibly other information such as a compression indicator, e.g. CpR. In some embodiments, signaling such as DCI may indicate the source distribution in a TB, e.g. whether the TB has one or multiple traffic packets, and/or the corresponding traffic types, and/or the ratio of traffic, which may be desired or required for joint source and channel decoding at receiver. In some embodiments, besides regular HARQ ACK/NACK feedback for channel decoding, the UE also reports ACK/NACK for source decoding, which may include reporting the source packet number and corresponding ACK/NACK status for that source packet number.

In some embodiments, if a TB carries one or more whole source packets, the DCI may include an indication of: source process number (e.g. indicate a source ID, where a source packet is assigned to a source process); and/or source compression scheme (e.g. indicate the CpR); and/or compression version; and/or a new source indicator (e.g. one bit that, if toggled compared to the value of the previous received transmission, indicates new source data)

In some embodiments, a source packet may be transmitted over several TBs, in which case the DCI may include an indication of: source process number (e.g. indicate a source ID, where a source packet is assigned to a source process); and/or segmentation information (e.g. indicate if the TB contains a complete packet, or first/last/middle segment); and/or segment offset (e.g. indicate the position of the current segment in the packet); and/or source compression scheme (e.g. indicate the CpR); and/or compression version; and/or a new source indicator (e.g. one bit that, if toggled compared to the value of the previous received transmission, indicates new source data).

Benefits of some embodiments are as follows. In current systems that implement HARQ, the HARQ method is limited to the channel coding. The underlying traffic to be transmitted (e.g. the TB) is transparent to the HARQ method. Instead, in some embodiments herein, source coding only, source coding and channel coding, or joint source and channel coding may be performed with a HARQ process that incorporates one or more features of the source coding, e.g. that intentionally favours retransmission of more significant blocks output from the source encoder. If channel coding is also implemented, the HARQ process may be referred to as a “dual-level” (or “two-level”) HARQ process because it operates on both the level of the channel coding and the level of the source coding. The feedback method may be referred to as a dual-level HARQ method. Future applications or use scenarios (e.g. 6G wireless communication) may involve information (e.g. traffic) resulting from sensing or artificial intelligence (AI) that allows and/or requires real-time or physical source coding and transmission with channel coding. Example scenarios may include sensing data/image transmission for network control, local AI data/model transmission, quality of service (QoS) based extended reality (XR) and virtual reality (VR) services, etc. In these scenarios or use cases, the network may take advantage of source and channel coding (possibly.JSCC) to try to optimize source encoding with un-constructed redundancy information and channel coding with constructed redundancy information for possibly more efficient transmissions over varying channels. The source encoded information may include different portions of source encoded (compressed) bits with different significance or importance to the source decoding, thus the source encoded information may possibly be utilized to enhance transmission efficiency in the sense that either certain source encoded bits are more critical to source decoding which may require delivery with higher priority to the receiver end correctly, or the transmitter end needs to retransmit specific erroneous source encoded bits (or source encoded blocks) that are reported (or fed back) by the receiver end. In this sense, the source coding information to be channel encoded and transmitted is no longer transparent to the transmitter end. Instead, both source encoded information and associated channel coding information are known to the transmitter, thus resulting in a possibly more effective initial transmission and/or re-transmission method over varying channel conditions. The methods may be implemented via source-channel dual-level HARQ operation, embodiments of which are described herein.

In some embodiments, when JSCC is implemented, the source coding procedure may produce or result in (e.g. extract/derive) different features that have different significance or importance to the source decoding. The HARQ method may be aware of these differentiated features to enhance joint source-channel decoding (.JSCD), e.g., a retransmission may give priority to higher significance source encoded bits or bit blocks while trying to reduce the air-link resource usage; or a retransmission may give priority to reported erroneous source encoded bits or bit blocks to improve both source and channel decoding. That is, in some embodiments dual-level HARQ methods are disclosed that take advantage of both source coding and channel coding information in HARQ operations for enhanced transmission efficiency and optimized JSCD. In some embodiments, the dual-level HARQ method prioritizes transmitting higher significance source encoded blocks over lower significance source encoded blocks to try to achieve more effective source decoding, and thus JSCD. Dual-level HARQ may take advantage of source context awareness to possibly perform more effective transmissions to enhance JSCD and/or spectrum efficiency.

The method of FIG. 7 is performed by two devices. Each device may include at least one processor and a memory storing processor-executable instructions that, when executed by the at least one processor, cause the device to perform its method steps in FIG. 7. A device may be a component of a UE or network device, e.g. an integrated circuit chip that controls the device to perform its method steps in FIG. 7. Many variations of FIG. 7 are described herein. Permutations of all of these variations and examples are contemplated. For example, any of the example methods for source encoding disclosed herein may be combined with any of the indications of source decoding outcome disclosed herein. As another example, the use of a SCV and/or a CRV for the first and second transmissions may be combined with any method of source encoding or any method of source decoding or any type of indication of source decoding outcome disclosed herein.

In addition to and consistent with the description above, the following examples are provided.

Example 1: A method performed by a device comprising: performing source encoding of information to result in source encoded bits; transmitting, in a first transmission, a first set of the source encoded bits comprising some or all of the source encoded bits; receiving an indication of source decoding outcome; in response to receiving the indication of source decoding outcome: transmitting, in a second transmission, a second set of the source encoded bits comprising some or all of the source encoded bits.

Example 2: The method of Example 1, wherein the second set of the source encoded bits is different from the first set of the source encoded bits.

Example 3: The method of Example 2, wherein the second set of the source encoded bits includes only a subset of the source encoded bits transmitted in the first transmission.

Example 4: The method of any one of Examples 1 to 3, wherein the source encoding performs compression of the information in the physical layer to generate the source encoded bits.

Example 5: The method of Example 4, wherein the source encoding is based on a source compression method that performs either lossless or lossy compression.

Example 6: The method of Example 5, wherein the source compression method implements one of: Lempel-Ziv-Welch (LZW), or principal component analysis (PCA), or integer multiwavelet transform (IMWT), or compression with reversible embedded wavelets (CREW), or discrete cosine transform (DCT).

Example 7: The method of any one of Examples 1 to 6, further comprising performing forward error correction channel encoding to generate parity bits, and wherein a first set of the parity bits are transmitted in the first transmission and a second set of the parity bits are transmitted in the second transmission.

Example 8: The method of Example 7, wherein the forward error correction channel encoding is performed on all of the source encoded bits to generate the parity bits, and wherein the first set of the parity bits and the second set of the parity bits are each different subsets of the parity bits.

Example 9: The method of Example 7, wherein the forward error correction channel encoding is performed on the source encoded bits transmitted in the first transmission to generate the first set of parity bits, and wherein the forward error correction channel encoding is separately performed on the source encoded bits transmitted in the second transmission to generate the second set of parity bits.

Example 10: The method of any one of Examples 7 to 9, wherein the number of the parity bits transmitted is dependent upon at least one of: (i) an allocated time-frequency resource, (ii) a channel coding rate, or (iii) a modulation scheme.

Example 11: The method of any one of Examples 1 to 10, further comprising including at least one cyclic redundancy check (CRC) value in the first transmission, and wherein the indication of source decoding outcome is based at least in part on a CRC check using the CRC value.

Example 12: The method of Example 11, comprising transmitting a respective CRC value for each portion of a plurality of portions of the source encoded bits transmitted in the first transmission; and wherein the indication of source decoding outcome indicates at least that a particular portion failed decoding based on a CRC check using the respective CRC value corresponding to the particular portion.

Example 13: The method of any one of Examples 1 to 12, wherein the indication of source decoding outcome is based on a source decoding distortion level.

Example 14: The method of Example 13, wherein the indication of source decoding outcome is based on a distortion threshold.

Example 15: The method of any one of Examples 1 to 14, wherein the indication of source decoding outcome comprises an indication of which of the source encoded bits to send in the second transmission.

Example 16: The method of Example 15, wherein the indication of which of the source encoded bits to send in the second transmission comprises: an indication of a source compression version (SCV) to use for the second transmission.

Example 17: The method of Example 15, wherein the indication of which of the source encoded bits to send in the second transmission is based on processing of artificial intelligence (AI) data.

Example 18: The method of any one of Examples 1 to 17, wherein the source encoded bits comprise a plurality of different portions, at least two of the portions having different levels of priority.

Example 19: The method of Example 18, wherein the first transmission includes some or all of the portions, wherein the indication of source decoding outcome indicates at least that a particular portion sent in the first transmission failed decoding, and wherein the particular portion is retransmitted in the second transmission.

Example 20: The method of Example 19, wherein the particular portion has a higher level of priority than one or more other portions.

Example 21: The method of Example 19 or 20, wherein the second transmission includes only a subset of the portions sent in the first transmission.

Example 22: The method of any one of Examples 1 to 21, wherein the second transmission is performed in response to receiving a negative acknowledgement (NACK) indicating at least one of unsuccessful source decoding or unsuccessful channel decoding.

Example 23: The method of any one of Examples 1 to 22, further comprising receiving a compression rate value configuring how many of the source encoded bits are to be transmitted in at least one of the first transmission or the second transmission.

Example 24: A device comprising: at least one processor; and a memory storing processor-executable instructions that, when executed by the at least one processor, cause the device to: perform source encoding of information to result in source encoded bits; transmit, in a first transmission, a first set of the source encoded bits comprising some or all of the source encoded bits; receive an indication of source decoding outcome; in response to receiving the indication of source decoding outcome: transmit, in a second transmission, a second set of the source encoded bits comprising some or all of the source encoded bits.

Example 25: The device of Example 24, wherein the second set of the source encoded bits is different from the first set of the source encoded bits.

Example 26: The device of Example 25, wherein the second set of the source encoded bits includes only a subset of the source encoded bits transmitted in the first transmission.

Example 27: The device of any one of Examples 24 to 26, wherein the source encoding performs compression of the information in the physical layer to generate the source encoded bits.

Example 28: The device of Example 27, wherein the source encoding is based on a source compression method that performs either lossless or lossy compression.

Example 29: The device of Example 28, wherein the source compression method implements one of: Lempel-Ziv-Welch (LZW), or principal component analysis (PCA), or integer multiwavelet transform (IMWT), or compression with reversible embedded wavelets (CREW), or discrete cosine transform (DCT).

Example 30: The device of any one of Examples 24 to 29, wherein the device is further caused to perform forward error correction channel encoding to generate parity bits, and wherein a first set of the parity bits are for transmission in the first transmission and a second set of the parity bits are for transmission in the second transmission.

Example 31: The device of Example 30, wherein the forward error correction channel encoding is performed on all of the source encoded bits to generate the parity bits, and wherein the first set of the parity bits and the second set of the parity bits are each different subsets of the parity bits.

Example 32: The device of Example 30, wherein the forward error correction channel encoding is performed on the source encoded bits transmitted in the first transmission to generate the first set of parity bits, and wherein the forward error correction channel encoding is separately performed on the source encoded bits transmitted in the second transmission to generate the second set of parity bits.

Example 33: The device of any one of Examples 30 to 32, wherein the number of the parity bits transmitted is dependent upon at least one of: (i) an allocated time-frequency resource, (ii) a channel coding rate, or (iii) a modulation scheme.

Example 34: The device of any one of Examples 24 to 33, wherein the device is further caused to include at least one cyclic redundancy check (CRC) value in the first transmission, and wherein the indication of source decoding outcome is based at least in part on a CRC check using the CRC value.

Example 35: The device of Example 34, wherein the device is caused to transmit a respective CRC value for each portion of a plurality of portions of the source encoded bits transmitted in the first transmission; and wherein the indication of source decoding outcome indicates at least that a particular portion failed decoding based on a CRC check using the respective CRC value corresponding to the particular portion.

Example 36: The device of any one of Examples 24 to 35, wherein the indication of source decoding outcome is based on a source decoding distortion level.

Example 37: The device of Example 36, wherein the indication of source decoding outcome is based on a distortion threshold.

Example 38: The device of any one of Examples 24 to 37, wherein the indication of source decoding outcome comprises an indication of which of the source encoded bits to send in the second transmission.

Example 39: The device of Example 38, wherein the indication of which of the source encoded bits to send in the second transmission comprises: an indication of a source compression version (SCV) to use for the second transmission.

Example 40: The device of Example 38, wherein the indication of which of the source encoded bits to send in the second transmission is based on processing of artificial intelligence (AI) data.

Example 41: The device of any one of Examples 24 to 40, wherein the source encoded bits comprise a plurality of different portions, at least two of the portions having different levels of priority.

Example 42: The device of Example 41, wherein the first transmission includes some or all of the portions, wherein the indication of source decoding outcome indicates at least that a particular portion sent in the first transmission failed decoding, and wherein the particular portion is retransmitted in the second transmission.

Example 43: The device of Example 42, wherein the particular portion has a higher level of priority than one or more other portions.

Example 44: The device of Example 42 or 43, wherein the second transmission includes only a subset of the portions sent in the first transmission.

Example 45: The device of any one of Examples 24 to 44, wherein the second transmission is performed in response to receiving a negative acknowledgement (NACK) indicating at least one of unsuccessful source decoding or unsuccessful channel decoding.

Example 46: The device of any one of Examples 24 to 45, wherein the device is further caused to receive a compression rate value configuring how many of the source encoded bits are to be transmitted in at least one of the first transmission or the second transmission.

Example 47: A method performed by a device comprising: receiving, in a first transmission, a first set of source encoded bits; transmitting an indication of source decoding outcome based on the first set of source encoded bits received in the first transmission; subsequently receiving, in a second transmission, a second set of source encoded bits.

Example 48: The method of Example 47, wherein the second set of source encoded bits is different from the first set of source encoded bits.

Example 49: The method of Example 48, wherein the second set of source encoded bits includes only a subset of the source encoded bits received in the first transmission.

Example 50: The method of any one of Examples 47 to 49, wherein the source encoded bits represent information compressed in the physical layer.

Example 51: The method of Example 50, wherein the compression is either lossless or lossy compression.

Example 52: The method of Example 51, wherein the compression implements one of: Lempel-Ziv-Welch (LZW), or principal component analysis (PCA), or integer multiwavelet transform (IMWT), or compression with reversible embedded wavelets (CREW), or discrete cosine transform (DCT).

Example 53: The method of any one of Examples 47 to 52, further comprising: receiving, in the first transmission, a first set of parity bits; and receiving, in the second transmission, a second set of parity bits; wherein the first set of parity bits and the second set of parity bits are for forward error correction.

Example 54: The method of Example 53, wherein the first set of parity bits and the second set of parity bits are each different subsets of parity bits output from forward error correction channel encoding of the source encoded bits.

Example 55: The method of Example 53, wherein the first set of parity bits are from forward error correction channel encoding of the first set of source encoded bits received in the first transmission, and wherein the second set of parity bits are from forward error correction channel encoding of the second set of source encoded bits received in the second transmission.

Example 56: The method of any one of Examples 53 to 55, wherein the number of the parity bits received is dependent upon at least one of: (i) an allocated time-frequency resource, (ii) a channel coding rate, or (iii) a modulation scheme.

Example 57: The method of any one of Examples 47 to 56, wherein the first transmission includes at least one cyclic redundancy check (CRC) value, and wherein the indication of source decoding outcome is based at least in part on a CRC check using the CRC value.

Example 58: The method of Example 57, comprising receiving a respective CRC value for each portion of a plurality of portions of source encoded bits received in the first transmission; and wherein the indication of source decoding outcome indicates at least that a particular portion failed decoding based on a CRC check using the respective CRC value corresponding to the particular portion.

Example 59: The method of any one of Examples 47 to 58, wherein the indication of source decoding outcome is based on a source decoding distortion level.

Example 60: The method of Example 59, wherein the indication of source decoding outcome is based on a distortion threshold.

Example 61: The method of any one of Examples 47 to 60, wherein the indication of source decoding outcome comprises an indication of which of the source encoded bits to send in the second transmission.

Example 62: The method of Example 61, wherein the indication of which of the source encoded bits to send in the second transmission comprises: an indication of a source compression version (SCV) to be used for the second transmission.

Example 63: The method of Example 61, wherein the indication of which of the source encoded bits to send in the second transmission is based on processing of artificial intelligence (AI) data.

Example 64: The method of any one of Examples 47 to 63, wherein the source encoded bits received in the first transmission comprise a plurality of different portions, at least two of the portions having different levels of priority.

Example 65: The method of Example 64, wherein the indication of source decoding outcome indicates at least that a particular portion received in the first transmission failed decoding, and wherein the particular portion is subsequently received in the second transmission.

Example 66: The method of Example 65, wherein the particular portion has a higher level of priority than one or more other portions.

Example 67: The method of any one of Examples 64 to 66, wherein the second transmission includes only a subset of the portions received in the first transmission.

Example 68: The method of any one of Examples 47 to 67, wherein the second transmission is received in response to transmitting a negative acknowledgement (NACK) upon at least one of unsuccessful source decoding or unsuccessful channel decoding.

Example 69: A device comprising: at least one processor; and a memory storing processor-executable instructions that, when executed by the at least one processor, cause the device to: receive, in a first transmission, a first set of source encoded bits; transmit an indication of source decoding outcome based on the first set of source encoded bits received in the first transmission; subsequently receive, in a second transmission, a second set of source encoded bits.

Example 70: The device of Example 69, wherein the second set of source encoded bits is different from the first set of source encoded bits.

Example 71: The device of Example 70, wherein the second set of source encoded bits includes only a subset of the source encoded bits received in the first transmission.

Example 72: The device of any one of Examples 69 to 71, wherein the source encoded bits represent information compressed in the physical layer.

Example 73: The device of Example 72, wherein the compression is either lossless or lossy compression.

Example 74: The device of Example 73, wherein the compression implements one of: Lempel-Ziv-Welch (LZW), or principal component analysis (PCA), or integer multiwavelet transform (IMWT), or compression with reversible embedded wavelets (CREW), or discrete cosine transform (DCT).

Example 75: The device of any one of Examples 69 to 74, wherein the device is further caused to: receive, in the first transmission, a first set of parity bits; and receive, in the second transmission, a second set of parity bits; wherein the first set of parity bits and the second set of parity bits are for forward error correction.

Example 76: The device of Example 75, wherein the first set of parity bits and the second set of parity bits are each different subsets of parity bits output from forward error correction channel encoding of the source encoded bits.

Example 77: The device of Example 75, wherein the first set of parity bits are from forward error correction channel encoding of the first set of source encoded bits received in the first transmission, and wherein the second set of parity bits are from forward error correction channel encoding of the second set of source encoded bits received in the second transmission.

Example 78: The device of any one of Examples 75 to 77, wherein the number of the parity bits received is dependent upon at least one of: (i) an allocated time-frequency resource, (ii) a channel coding rate, or (iii) a modulation scheme.

Example 79: The device of any one of Examples 69 to 78, wherein the first transmission includes at least one cyclic redundancy check (CRC) value, and wherein the indication of source decoding outcome is based at least in part on a CRC check using the CRC value.

Example 80: The device of Example 79, wherein the device is caused to receive a respective CRC value for each portion of a plurality of portions of source encoded bits received in the first transmission; and wherein the indication of source decoding outcome indicates at least that a particular portion failed decoding based on a CRC check using the respective CRC value corresponding to the particular portion.

Example 81: The device of any one of Examples 69 to 80, wherein the indication of source decoding outcome is based on a source decoding distortion level.

Example 82: The device of Example 81, wherein the indication of source decoding outcome is based on a distortion threshold.

Example 83: The device of any one of Examples 69 to 82, wherein the indication of source decoding outcome comprises an indication of which of the source encoded bits to send in the second transmission.

Example 84: The device of Example 83, wherein the indication of which of the source encoded bits to send in the second transmission comprises: an indication of a source compression version (SCV) to be used for the second transmission.

Example 85: The device of Example 83, wherein the indication of which of the source encoded bits to send in the second transmission is based on processing of artificial intelligence (AI) data.

Example 86: The device of any one of Examples 69 to 85, wherein the source encoded bits received in the first transmission comprise a plurality of different portions, at least two of the portions having different levels of priority.

Example 87: The device of Example 86, wherein the indication of source decoding outcome indicates at least that a particular portion received in the first transmission failed decoding, and wherein the particular portion is subsequently received in the second transmission.

Example 88: The device of Example 87, wherein the particular portion has a higher level of priority than one or more other portions.

Example 89: The device of any one of Examples 86 to 88, wherein the second transmission includes only a subset of the portions received in the first transmission.

Example 90: The device of any one of Examples 69 to 89, wherein the second transmission is received in response to transmitting a negative acknowledgement (NACK) upon at least one of unsuccessful source decoding or unsuccessful channel decoding.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor readable storage media.

1. A method performed by a device, the method comprising:
performing source encoding of information to result in source encoded bits;
transmitting, in a first transmission, a first set of the source encoded bits comprising some or all of the source encoded bits;
receiving an indication of a source decoding outcome; and
in response to the receiving the indication of the source decoding outcome: transmitting, in a second transmission, a second set of the source encoded bits comprising some or all of the source encoded bits.

2. The method of claim 1, wherein the second set of the source encoded bits is different from the first set of the source encoded bits.

3. The method of claim 1, wherein the indication of the source decoding outcome is based on a source decoding distortion level.

4. The method of claim 1, wherein the indication of the source decoding outcome comprises an indication of the second set of the source encoded bits.

5. The method of claim 1, wherein the source encoded bits comprise a plurality of different portions, at least two portions of the plurality of different portions having different levels of priority.

6. The method of claim 5, wherein the first transmission includes some or all of the plurality of different portions, wherein the indication of the source decoding outcome indicates at least that a portion sent in the first transmission failed decoding, and wherein the portion is retransmitted in the second transmission.

7. A device comprising:
at least one processor coupled with a memory storing processor-executable instructions that, when executed by the at least one processor, cause the device to:
perform source encoding of information to result in source encoded bits;
transmit, in a first transmission, a first set of the source encoded bits comprising some or all of the source encoded bits;
receive an indication of a source decoding outcome; and
in response to receiving the indication of the source decoding outcome: transmit, in a second transmission, a second set of the source encoded bits comprising some or all of the source encoded bits.

8. The device of claim 7, wherein the second set of the source encoded bits is different from the first set of the source encoded bits.

9. The device of claim 7, wherein the indication of the source decoding outcome is based on a source decoding distortion level.

10. The device of claim 7, wherein the indication of the source decoding outcome comprises an indication of the second set of the source encoded bits.

11. The device of claim 7, wherein the source encoded bits comprise a plurality of different portions, at least two portions of the plurality of different portions having different levels of priority.

12. The device of claim 11, wherein the first transmission includes some or all of the plurality of different portions, wherein the indication of the source decoding outcome indicates at least that a portion sent in the first transmission failed decoding, and wherein the portion is retransmitted in the second transmission.

13. The device of claim 12, wherein the portion has a higher level of priority than one or more other portions of the plurality of different portions.

14. A device comprising:
at least one processor coupled with a memory storing processor-executable instructions that, when executed by the at least one processor, cause the device to:
receive, in a first transmission, a first set of source encoded bits;
transmit an indication of a source decoding outcome based on the first set of source encoded bits received in the first transmission; and
subsequently receive, in a second transmission, a second set of source encoded bits comprising some or all of the source encoded bits.

15. The device of claim 14, wherein the second set of source encoded bits is different from the first set of source encoded bits.

16. The device of claim 14, wherein the indication of the source decoding outcome is based on a source decoding distortion level.

17. The device of claim 14, wherein the indication of the source decoding outcome comprises an indication of the second set of the source encoded bits.

18. The device of claim 14, wherein the source encoded bits comprise a plurality of different portions, at least two portions of the plurality of different portions having different levels of priority.

19. The device of claim 18, wherein the indication of the source decoding outcome indicates at least that a portion received in the first transmission failed decoding, and wherein the portion is subsequently received in the second transmission.

20. The device of claim 19, wherein the portion has a higher level of priority than one or more other portions of the plurality of different portions.
